(19) United States
(12) Patent Application Publication
(10) Pub. No.: US 2015/0218714 A1
(43) Pub. Date: Aug. 6, 2015

(54) SYSTEMS AND METHODS FOR THE CONTROL OF HYDROGEN PRODUCTION

(71) Applicant: James D. Dees, Phoenix, AZ (US)

(72) Inventor: James D. Dees, Phoenix, AZ (US)

(21) Appl. No.: 14/578,480

(22) Filed: Dec. 21, 2014

Related U.S. Application Data
(63) Continuation of application No. 13/483,000, filed on May 29, 2012, now abandoned.
Application No. 13/483,000 is a continuation-in-part of application No. 13/625,827, filed on Sep. 24, 2012.
Application No. 13/625,827 is a continuation of application No. 12/454,032, filed on May 11, 2009, now Pat. No. 8,303,798.
Application No. 12/454,032 is a continuation of application No. 12/454,032, filed on May 11, 2009, now Pat. No. 8,303,798.
(60) Provisional application No. 61/491,183, filed on May 28, 2011.

(51) Int. Cl. C25B 1/04; F02M 25/12; F02B 43/10

(52) U.S. Cl. CPC C25B 1/04; F02B 43/10; F02M 25/12

(57) ABSTRACT

The disclosure of the present application provides systems, and methods for the generation of hydrogen. In at least one example of u system of the present application, the device is operable to couple to a combustion engine. In at least one example, hydrogen generated by the hydrogen generating system is operable to increase the fuel combustion efficiency of a combustion engine.

### CROSS-REFERENCE TO RELATED APPLICATIONS

This application is a continuation of, and claims the benefit of U.S. patent application Ser. No. 13/483,000 filed May 29, 2012 which in turn claims priority to U.S. Provisional Patent Application No. 61/491,183 filed May 28, 2011, the contents of which are hereby incorporated by reference. This application is also a continuation in part of, and claims the benefit of, U.S. patent application Ser. No. 13/625,827 filed Sep. 24, 2012 which is a continuation of U.S. patent application Ser. No. 12/454,032 filed May 11, 2009, now issued U.S. Pat. No. 8,303,798, the contents of which are hereby incorporated by reference. This application is related to abandoned U.S. Provisional Patent Application Ser. No. 61/196,698, filed May 11, 2008 and to abandoned U.S. Provisional Patent Application No. 61/250,643, filed Oct. 12, 2009.

### TECHNICAL FIELD

This description relates generally to systems and methods for increasing the efficiency of internal combustion engines and more specifically to systems and methods for generating hydrogen gas.

### BACKGROUND

During the initial stages of combustion in a diesel engine, only air is introduced into the combustion chamber. The air is then compressed with a compression ratio typically between 15:1 and 22:1 resulting into a 40 bar (about 600 psi) pressure compared to 8 to 14 bar (about 200 psi) in the engine. This high compression locally heats the air to 550° C. (about 1000° F.). At about this moment, fuel is injected directly into the compressed air in the combustion chamber, either into a void in the top of the piston or a ‘pre-chamber’ depending upon the design of the engine. The fuel injector ensures that the fuel is broken down into small droplets, and that the fuel is distributed as evenly as possible. The heat of the compressed air vaporizes fuel from the surface of the droplets. The vapor is then ignited by the heat from the compressed air in the combustion chamber, and the droplets continue to vaporize from their surfaces and burn, getting smaller, until all the fuel in the droplets has been burnt.

Diesel engines produce very little carbon monoxide as they bum the fuel in excess air even at full load, at which point the quantity of fuel injected per cycle is still about 50% lean of stoichiometric. However, they can produce black soot (or more specifically diesel particulate matter) from their exhaust, which consists of unburned carbon compounds. This is caused by local low temperatures where the fuel is not fully atomized. These local low temperatures occur at the cylinder walls and at the outside of large droplets of fuel. At areas where it is relatively cold, the mixture is rich (contrary to the overall mixture, which is lean). The rich mixture has less air to bum and some of the fuel turns into a carbon deposit.

The full load limit of a diesel engine in normal service is defined by the “black smoke limit”, beyond which point the fuel cannot be completely combusted, as the black smoke limit is still considerably lean of stoichiometric. It is possible to obtain more power by exceeding it, but the resultant inefficient combustion means that the extra power comes at the price of reduced combustion efficiency, high fuel consumption and dense clouds of smoke. This is typically only done in specialized applications where these disadvantages are of little concern.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a hydrogen generating system comprising a container, at least one hydrogen generating cell positioned within the container (each hydrogen generating cell including, a positive electrode, a negative electrode, and at least one neutral material positioned between the positive electrode and the negative electrode). A liquid positioned within the container, the liquid contacting the positive electrode, the negative electrode, and the at least one neutral material, and a power source operably coupled to the positive electrode of at least one hydrogen generating cell, the power source operable to provide a current to the positive electrode. Wherein when the current from the power source is provided to the positive electrode, the at least one hydrogen generating cell releases hydrogen through electrolysis.

Many of the attendant features will be more readily appreciated as the same becomes better understood by reference to the following detailed description considered in connection with the accompanying drawings.

DESCRIPTION OF THE DRAWINGS

The present description will be better understood from the following detailed description read in light of the accompanying drawings, wherein:

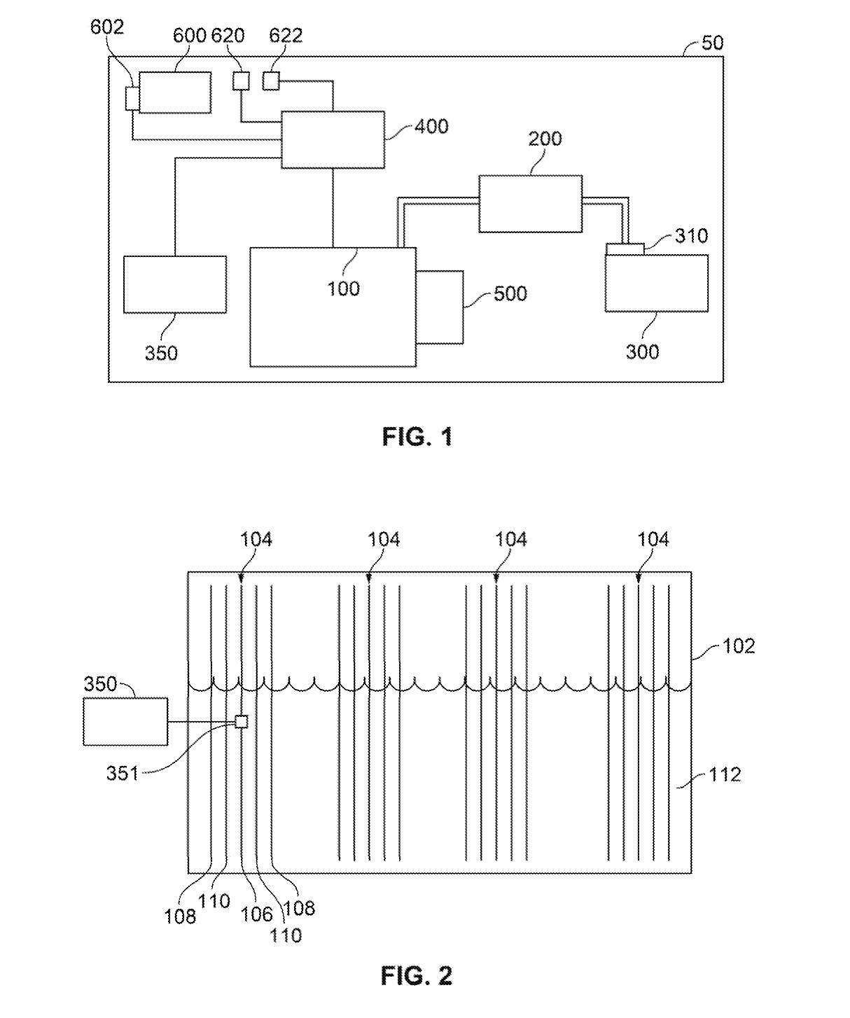

FIG. 1 shows a diagram of at least one example of a hydrogen generating system of the present disclosure mounted on a vehicle;

FIG. 2 shows a front planar view of at least one example of a hydrogen generating system of the present disclosure;

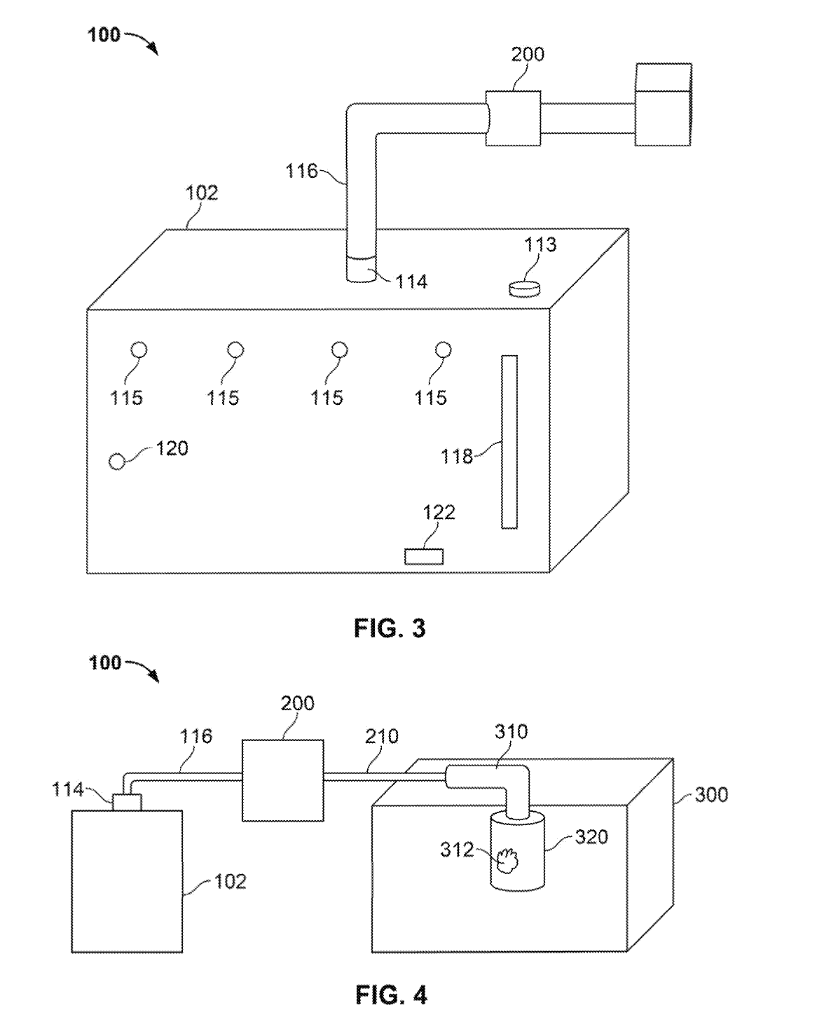

FIG. 3 shows a front perspective view of at least one example of a hydrogen generating system of the present disclosure;

FIG. 4 shows a front perspective view of at least one example of a combustion engine of the present disclosure;

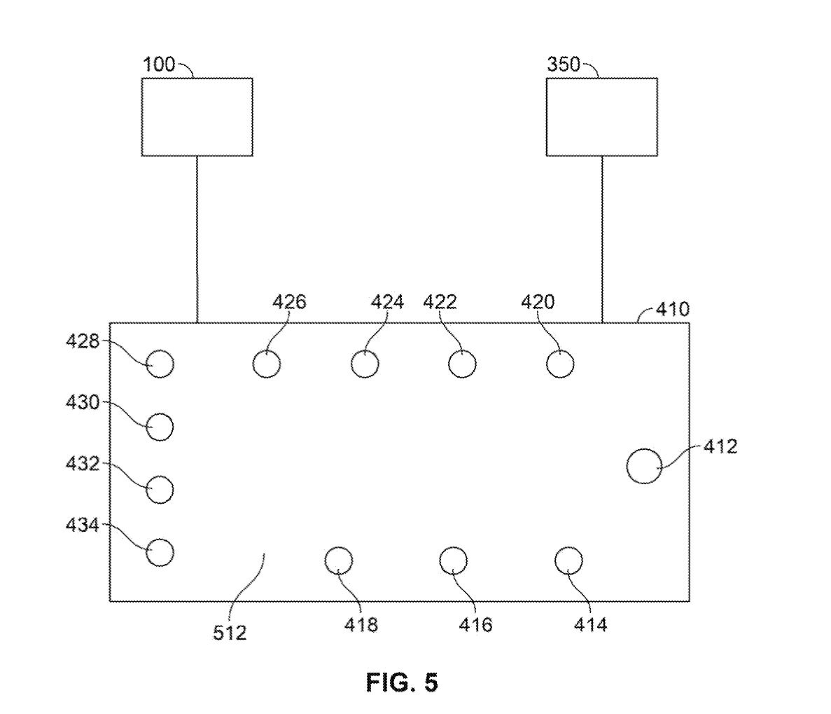

FIG. 5 shows a front planar view of at least one example of a control system of the present disclosure;

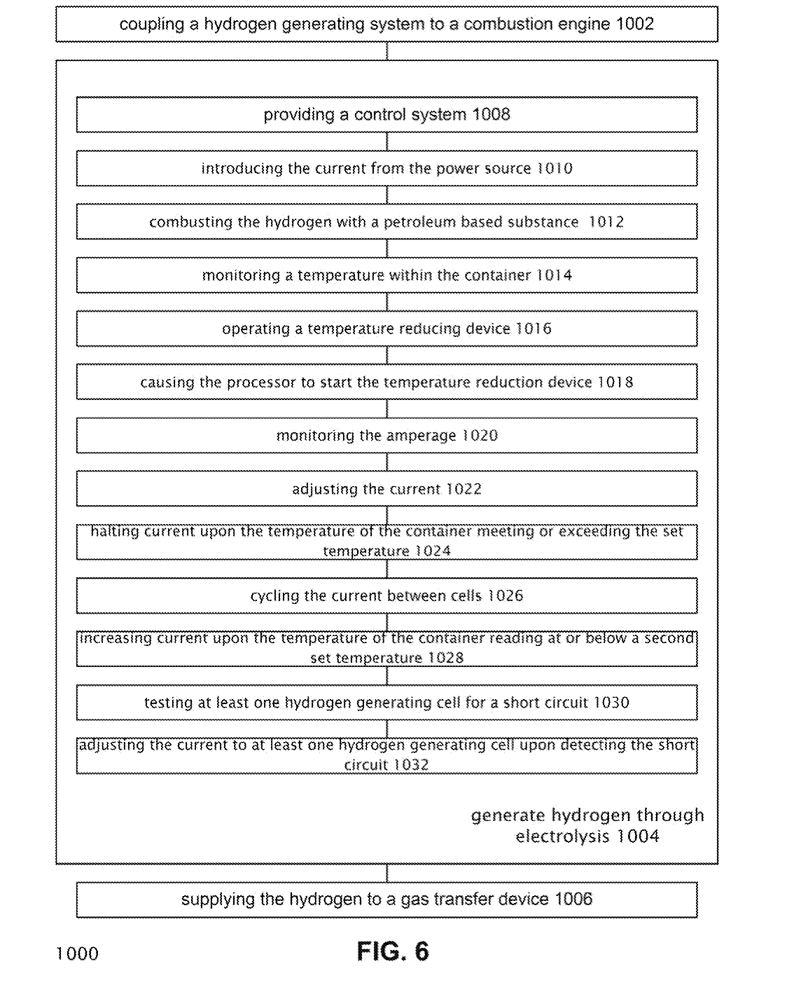

FIG. 6 shows a flowchart of at least one-example of a method for producing hydrogen of the present disclosure;

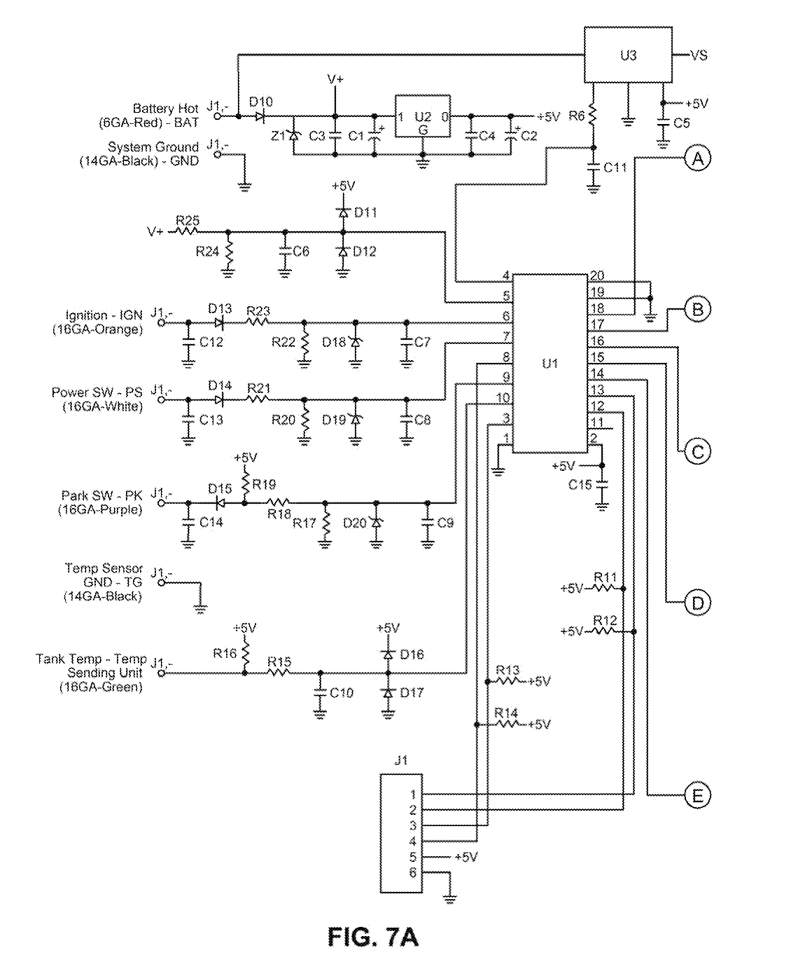

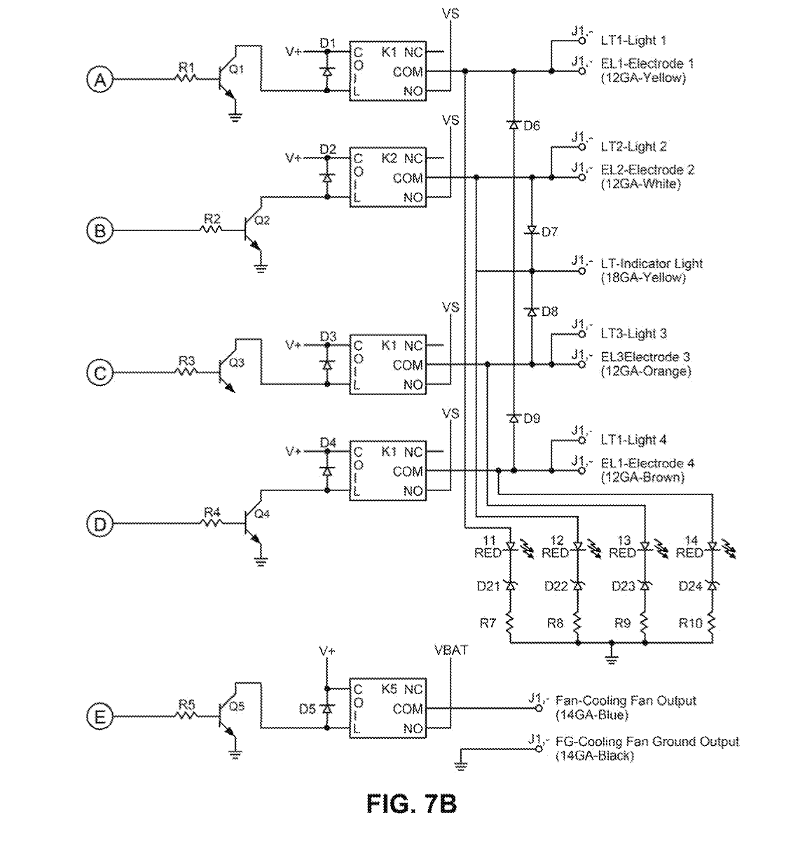

FIGS. 7A and 7B shows an electrical diagram of at least one example of a control system of the present disclosure;

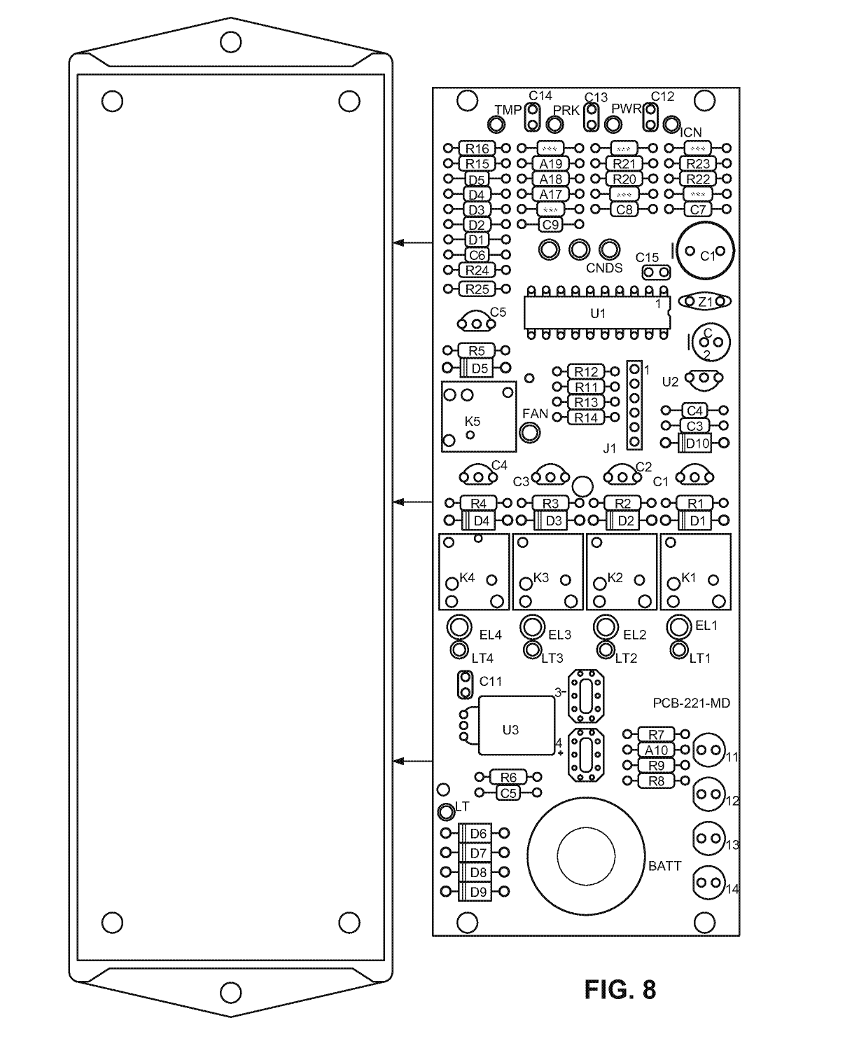

FIG. 8 shows a front planar view of at least one example of a control system of the present disclosure;

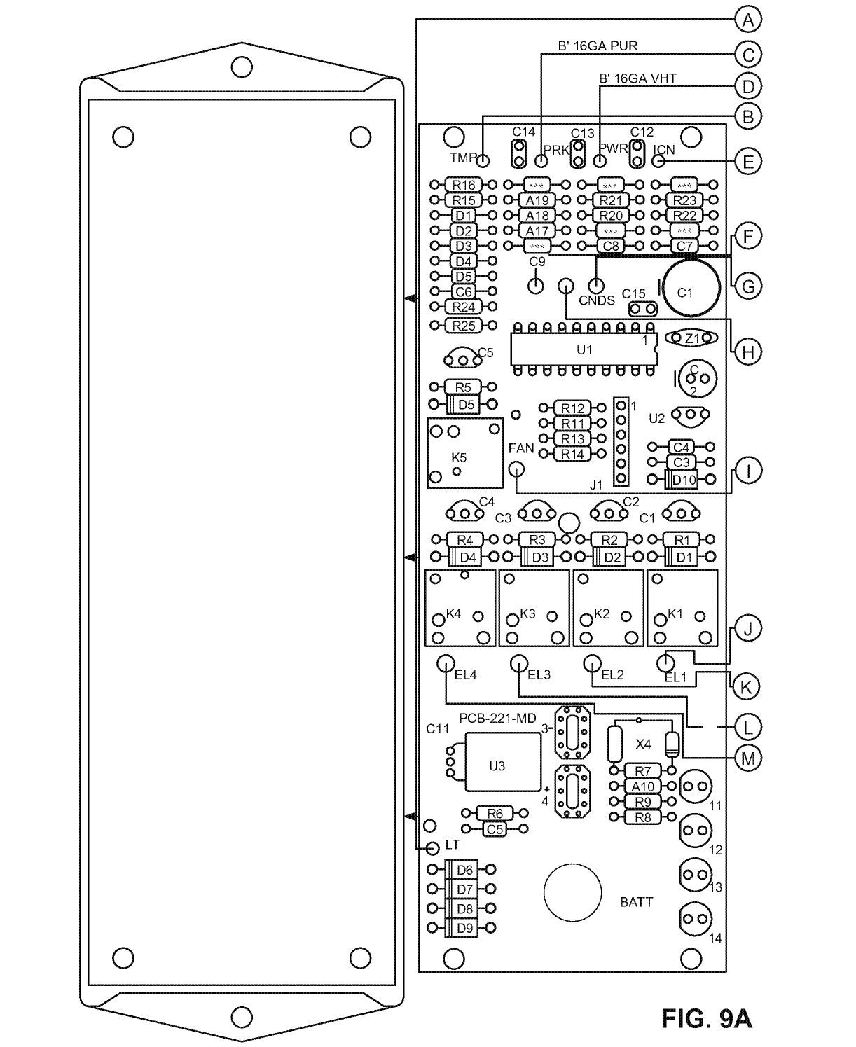

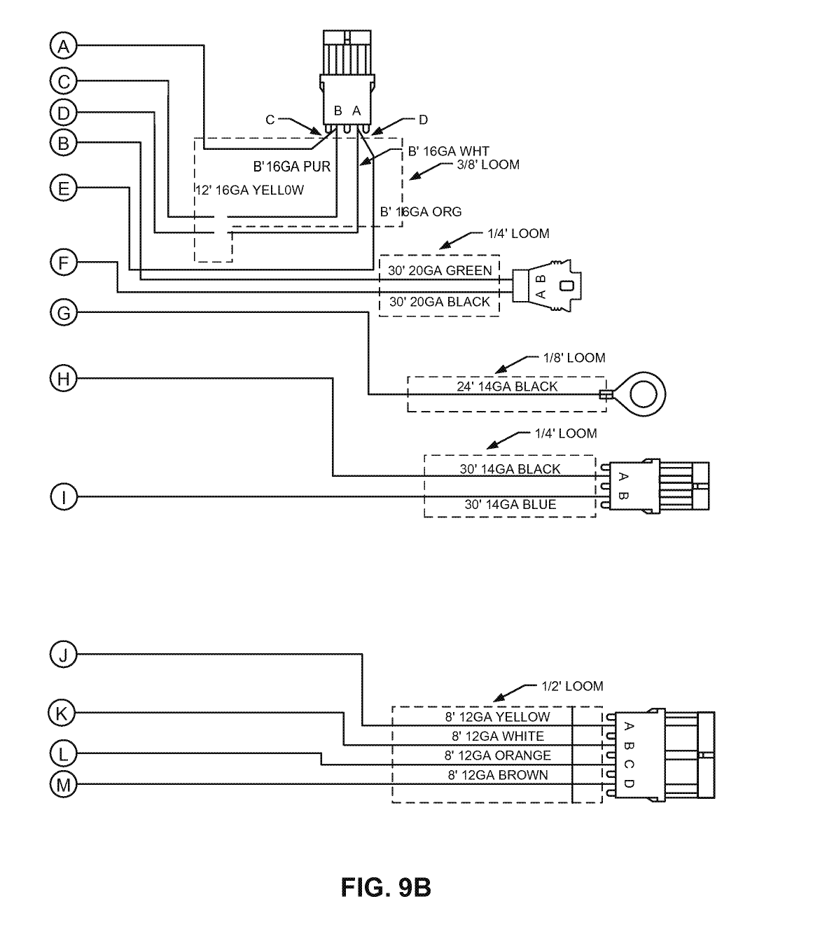

FIGS. 9A and 9B shows a planar view of at least one example of a control system of the present disclosure;

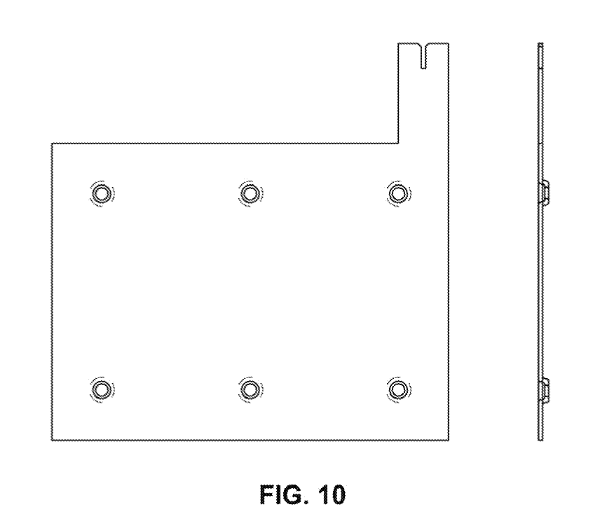

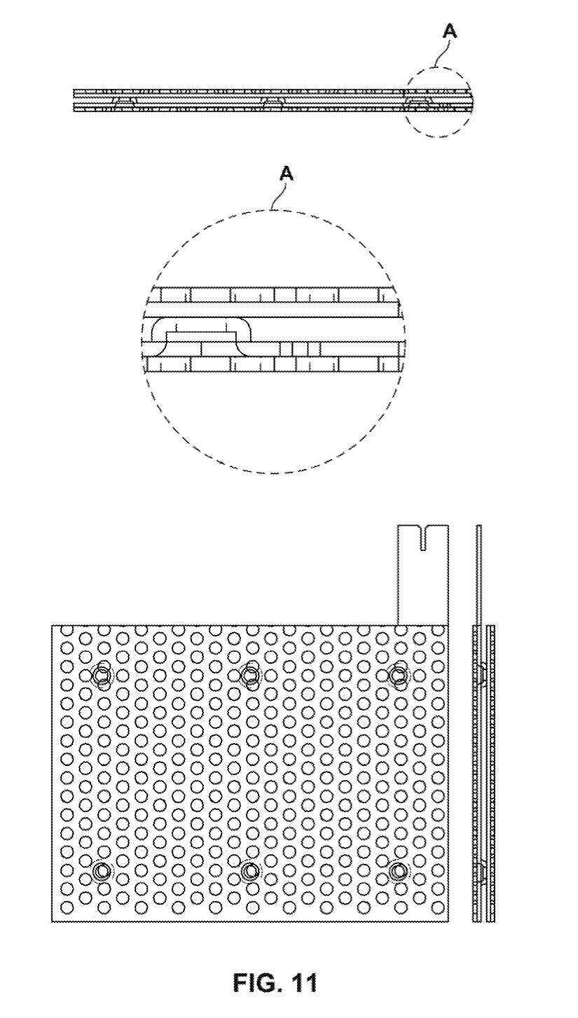

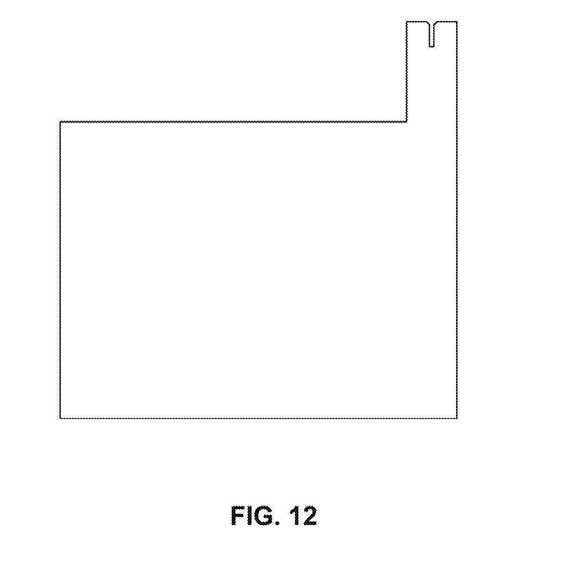

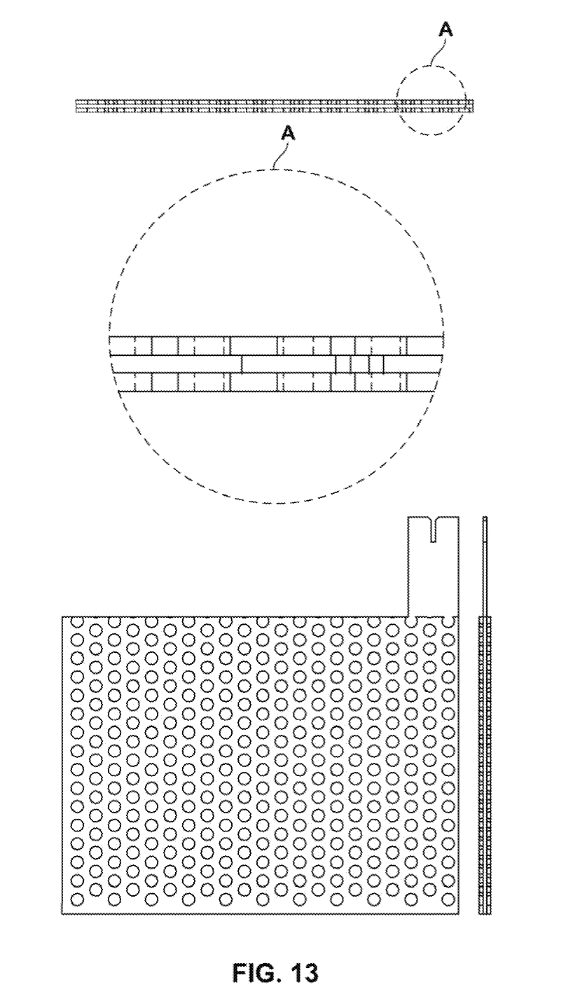

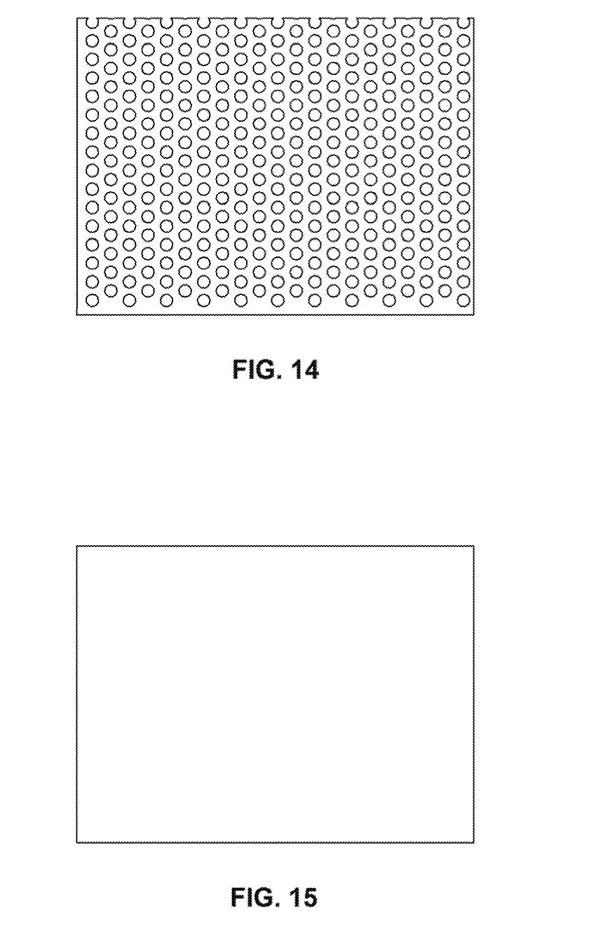

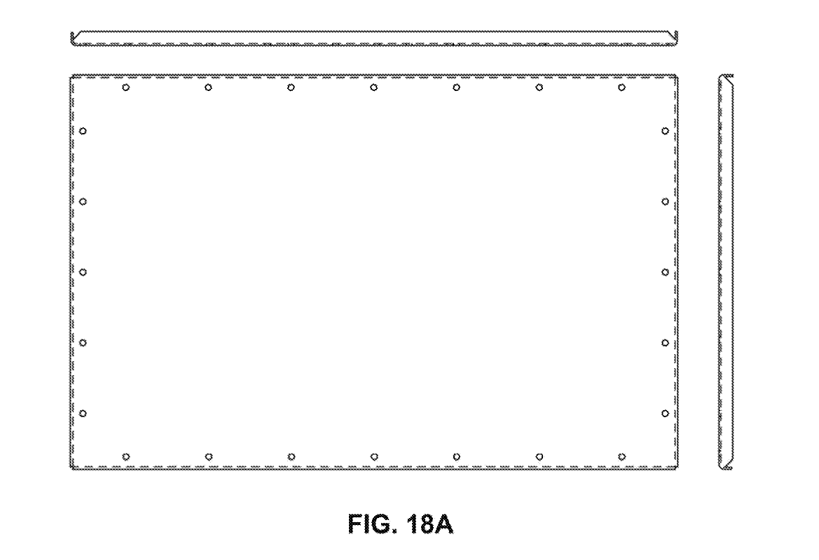

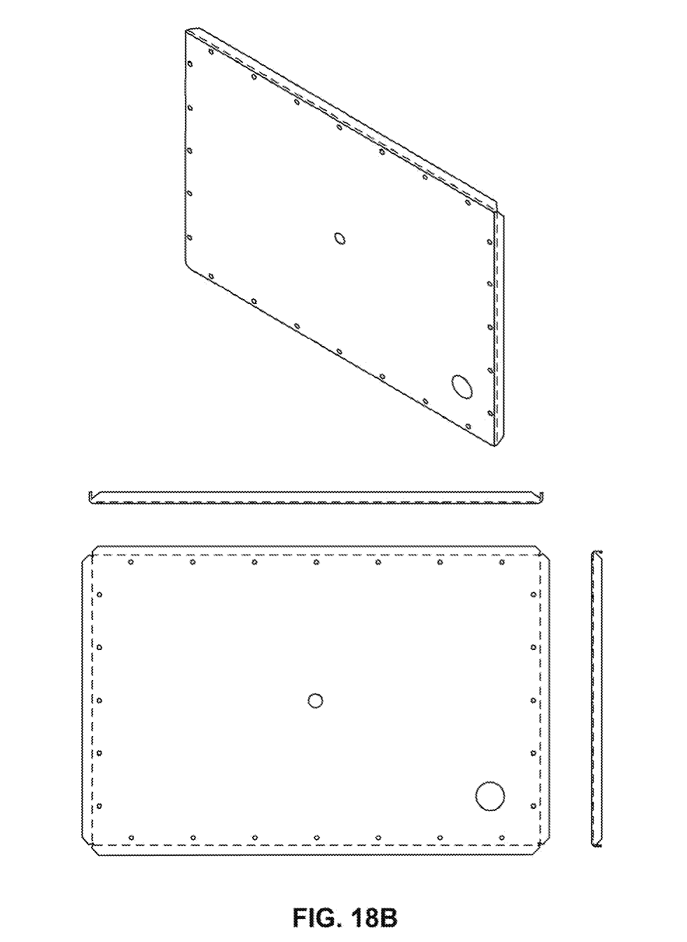

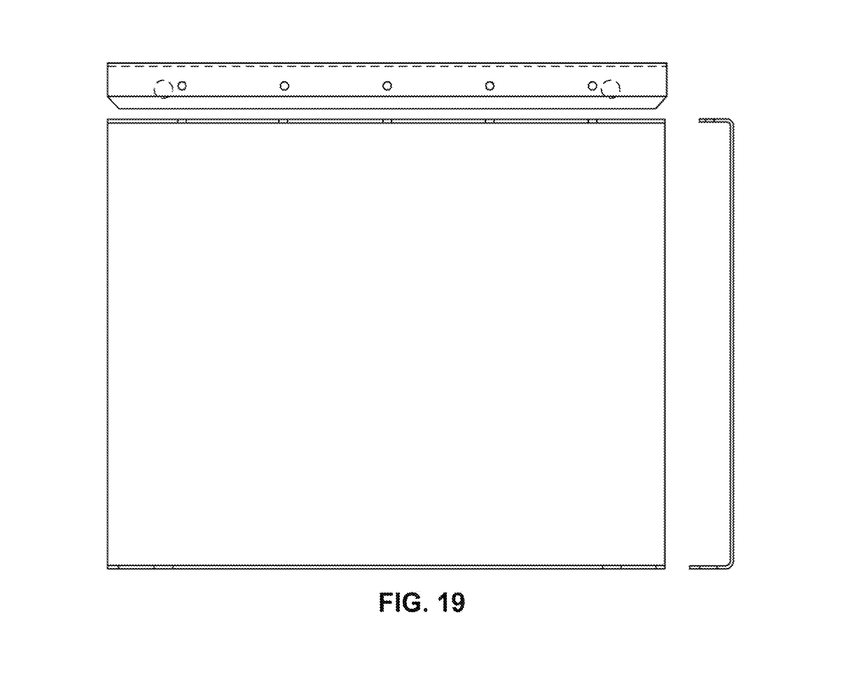

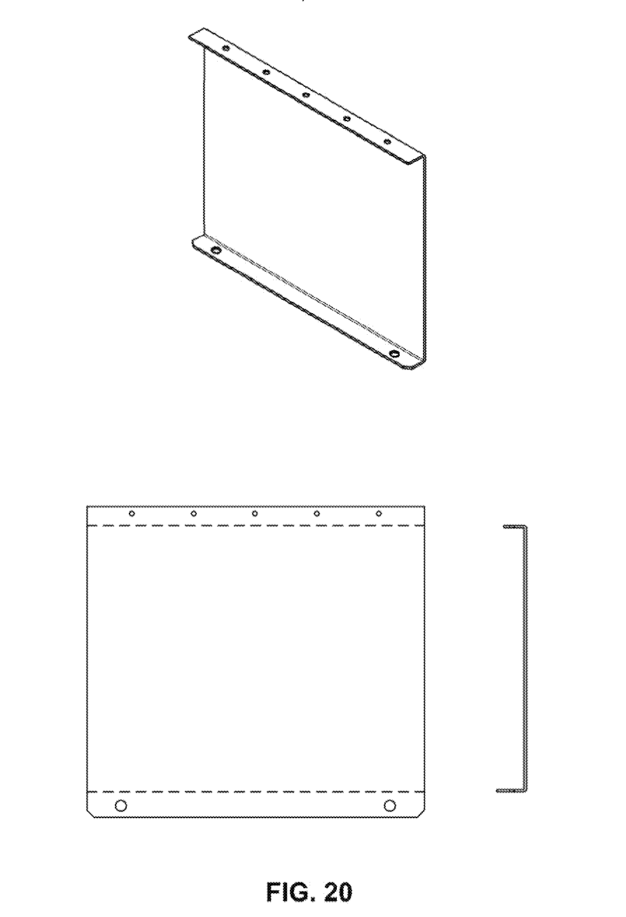

FIGS. 10, 11, 12, 13, 14, 15, 16, 17, 18A. 18B, 19, 20, 21, 22, 23, 24 are schematic drawings of components of at least one example of a hydrogen generating system of the present disclosure; and

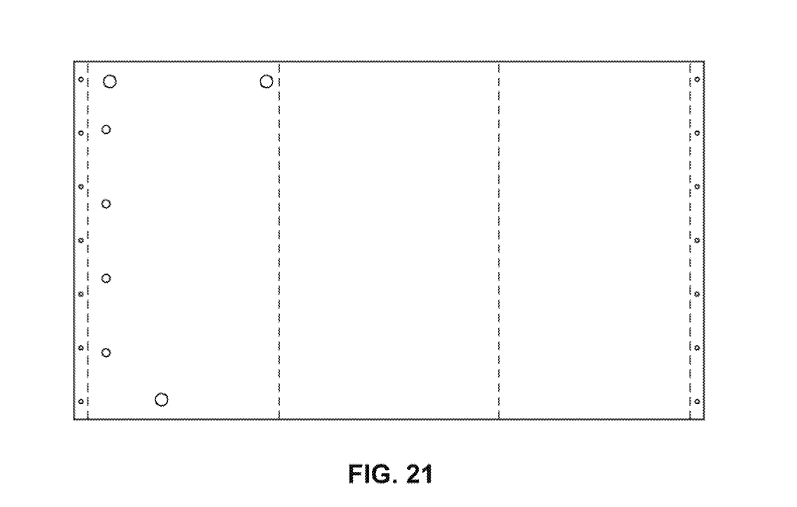

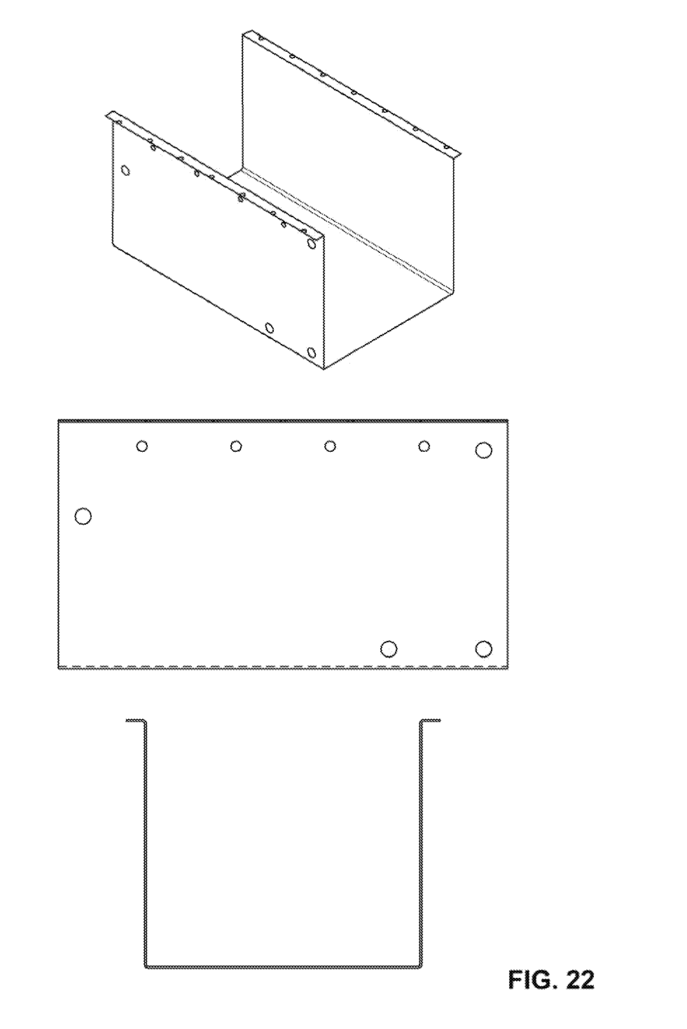

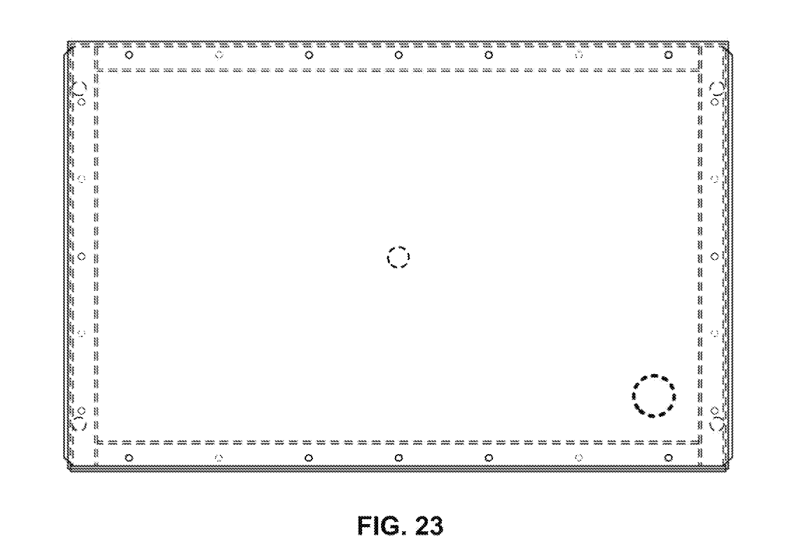

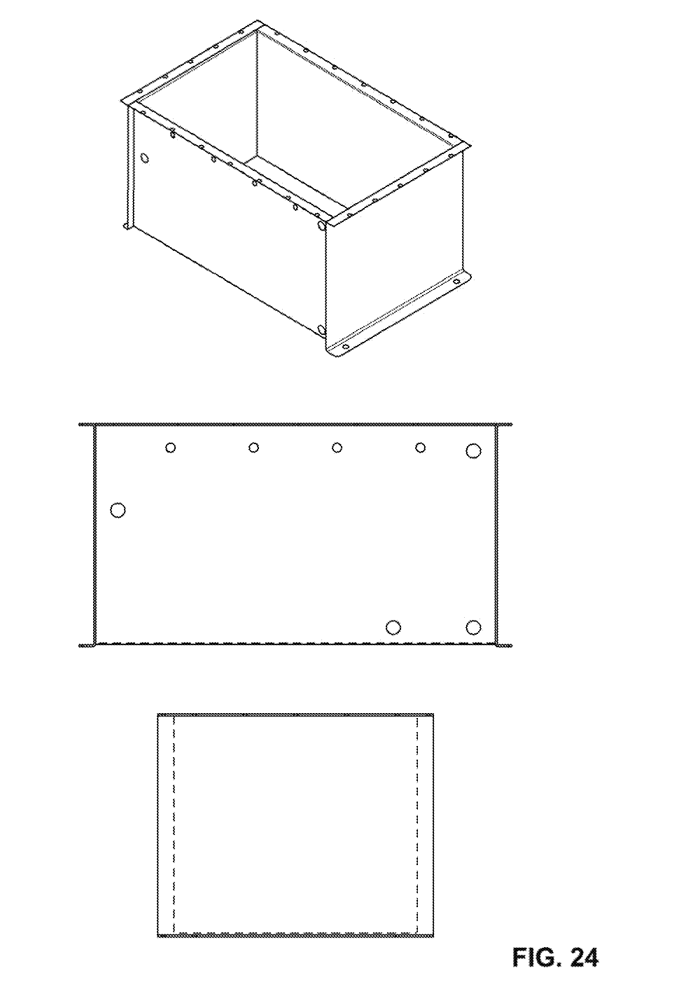

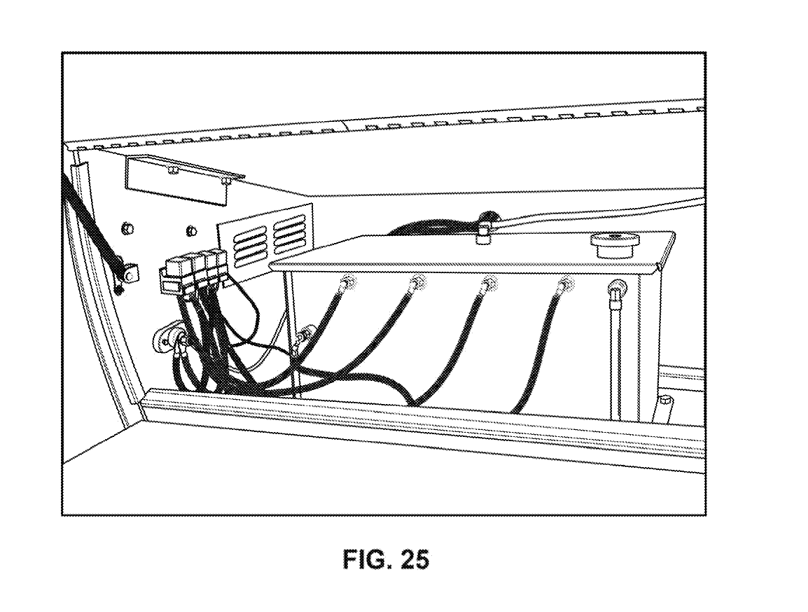

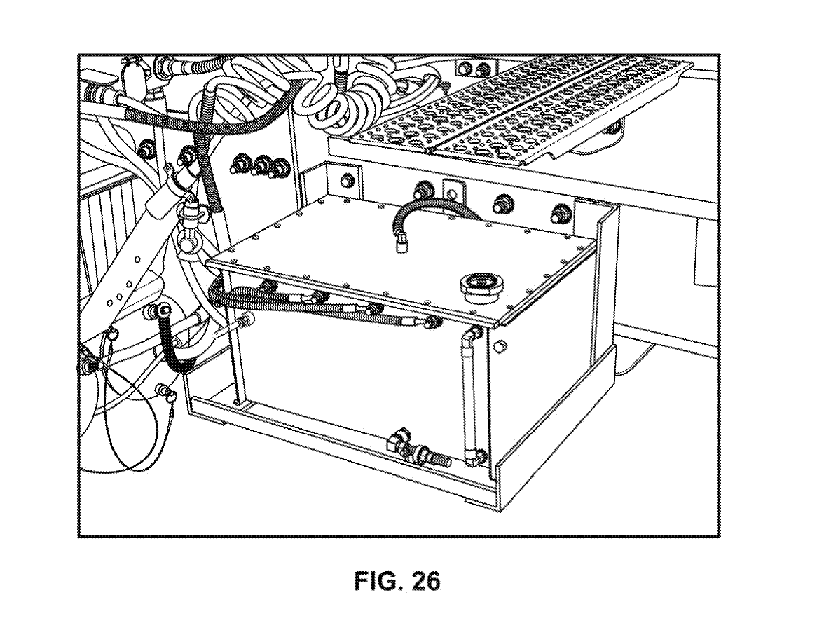

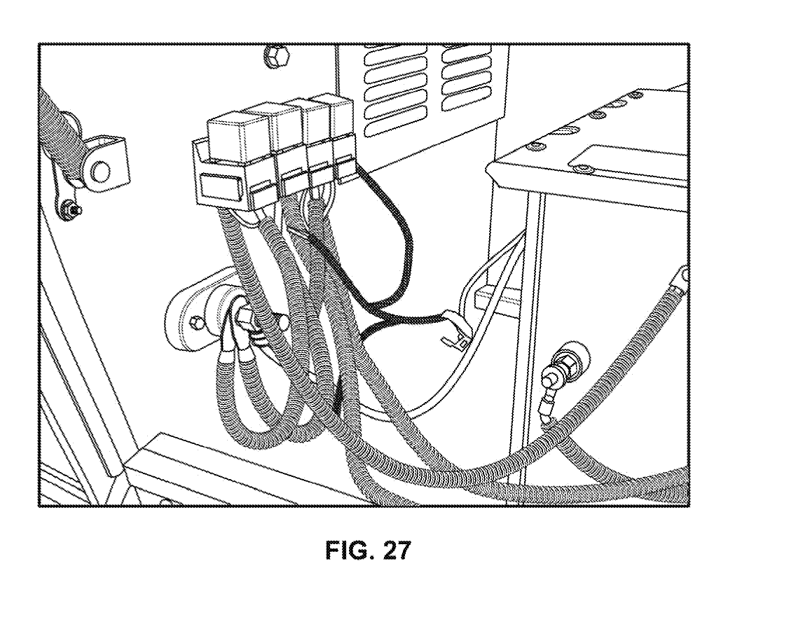

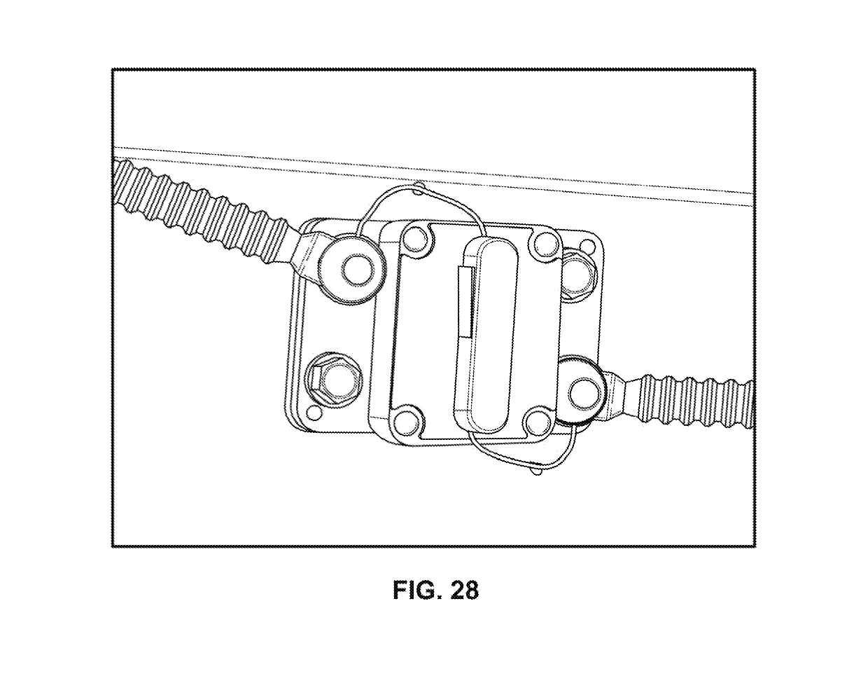

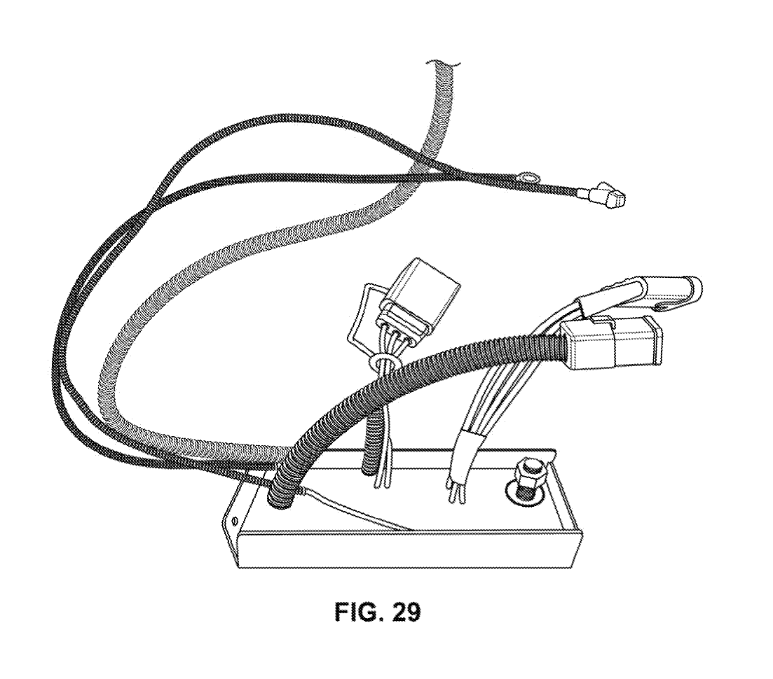

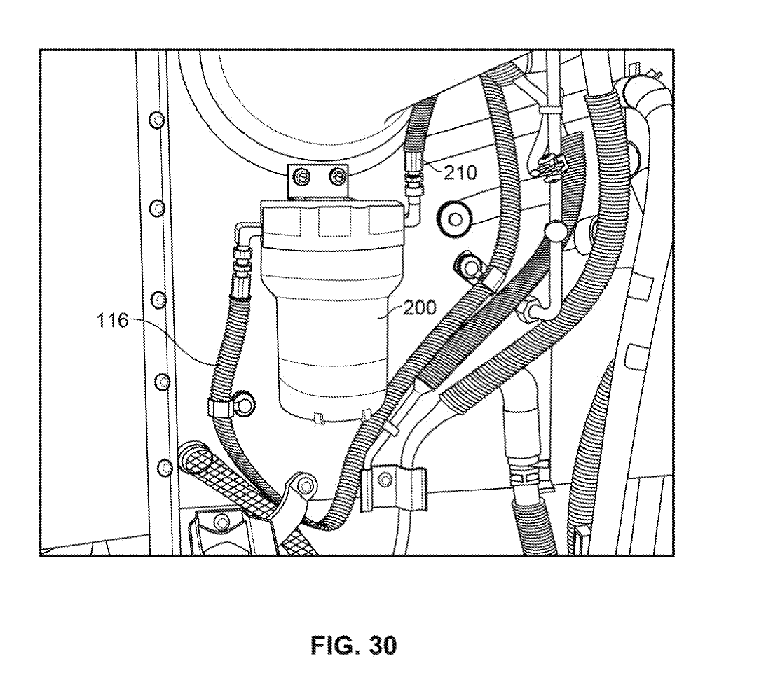

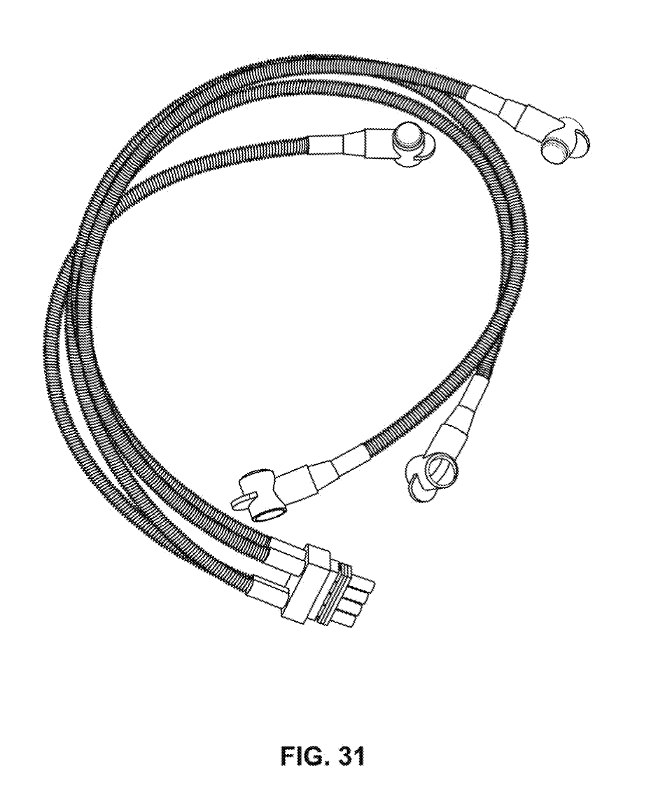

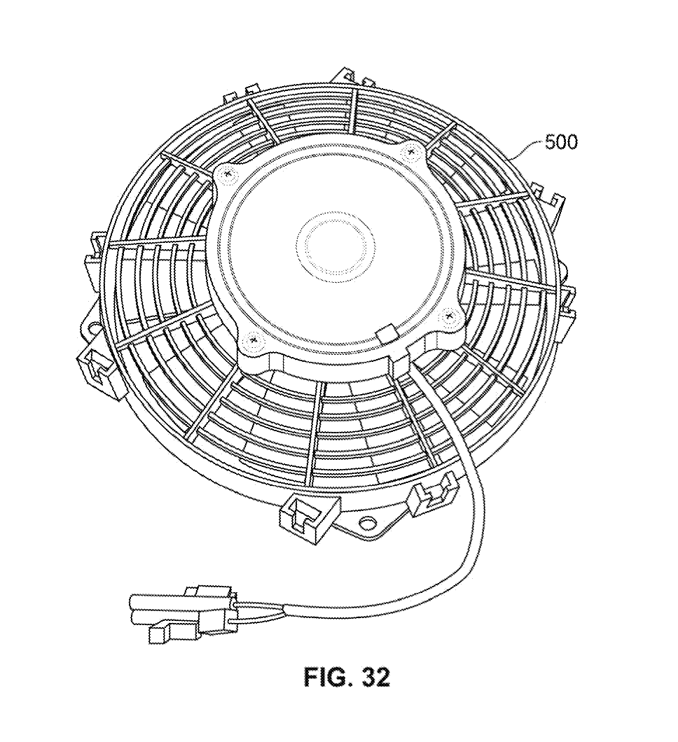

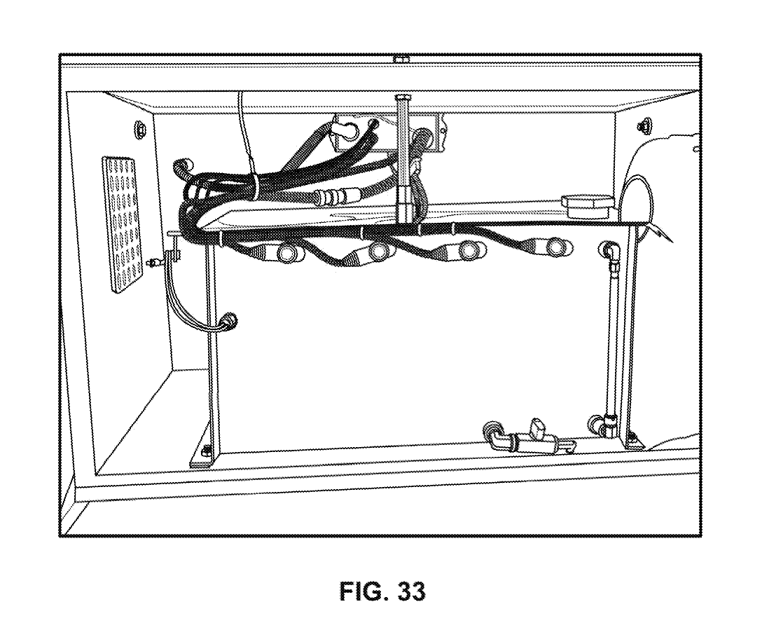

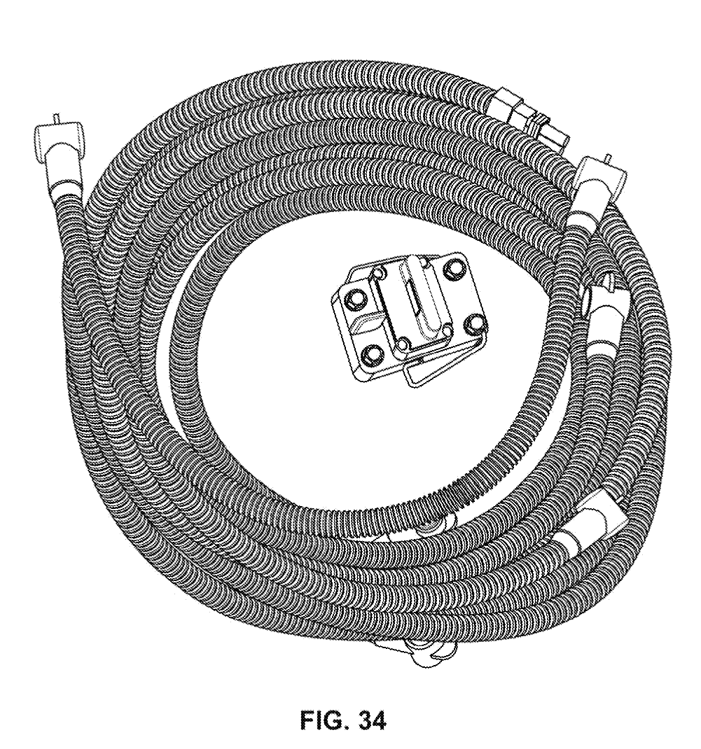

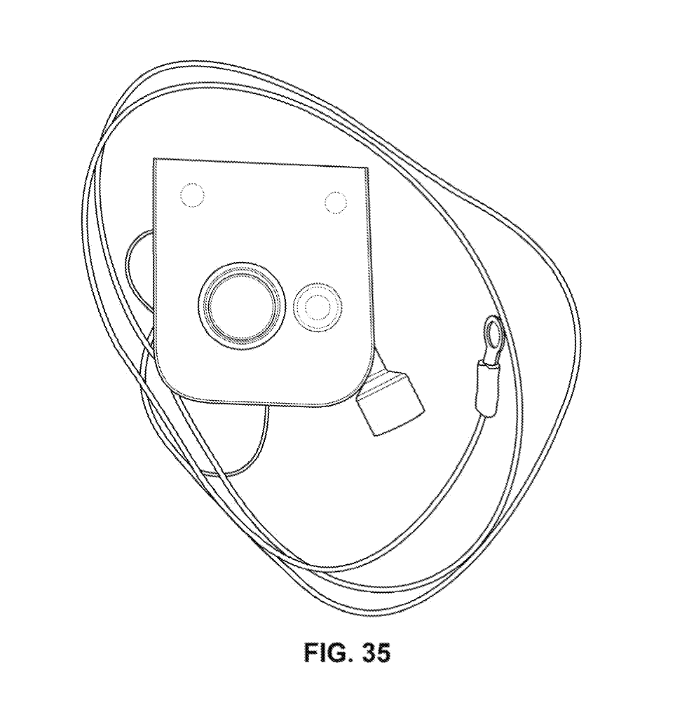

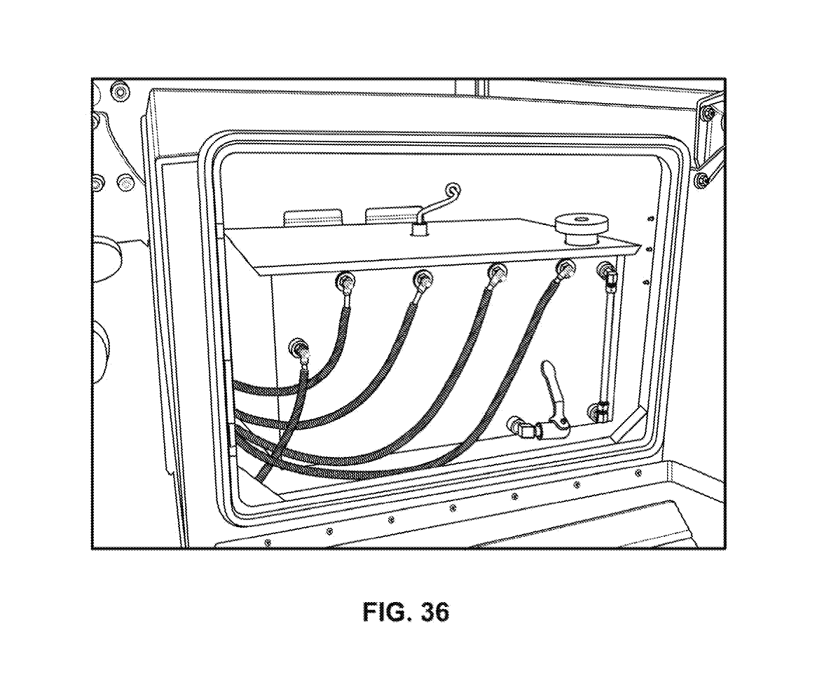

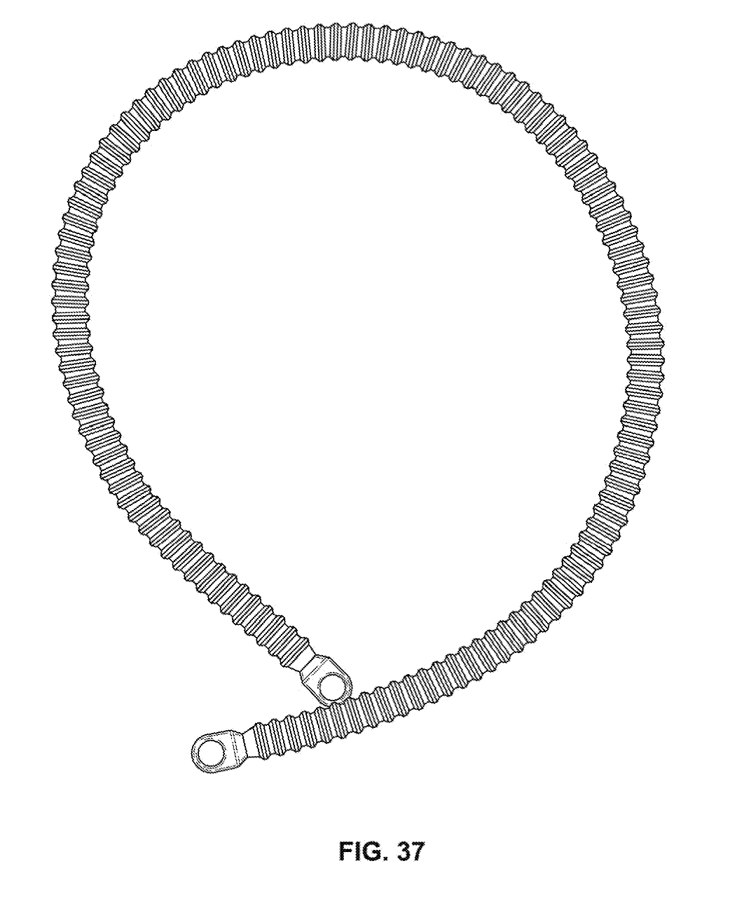

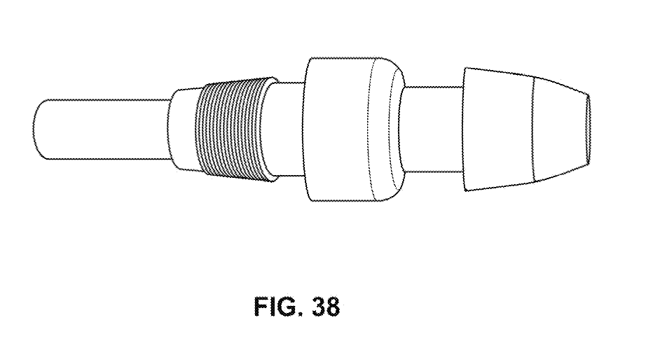

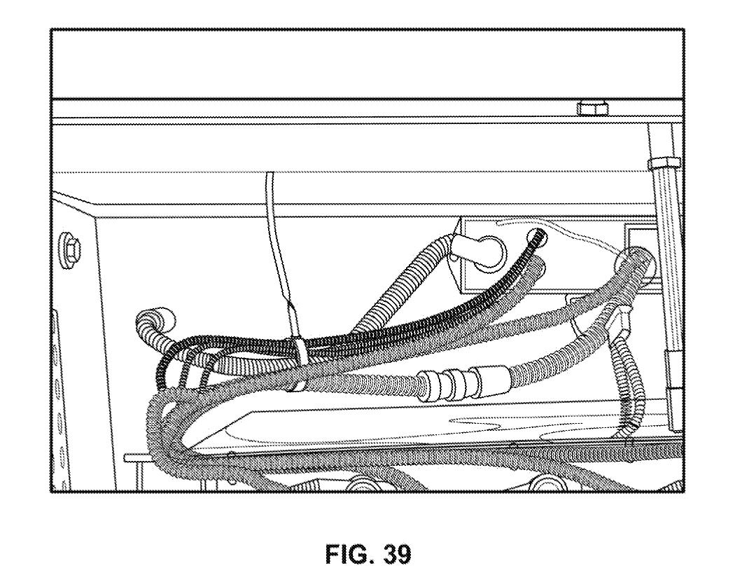

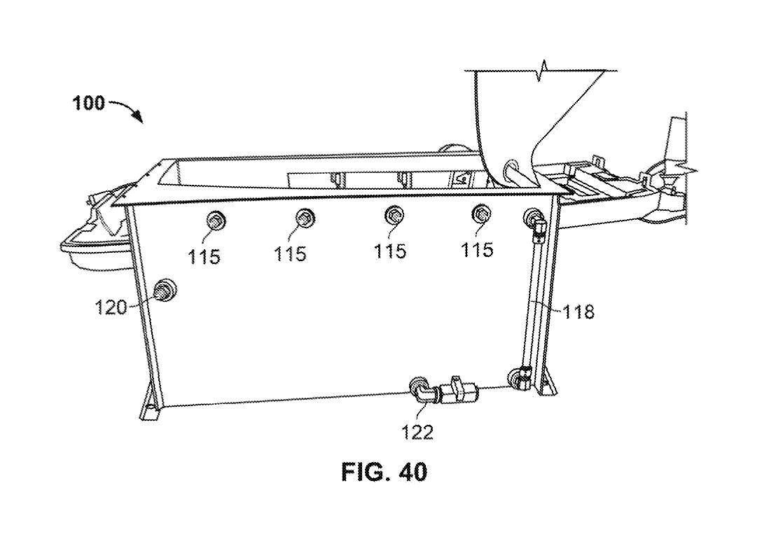

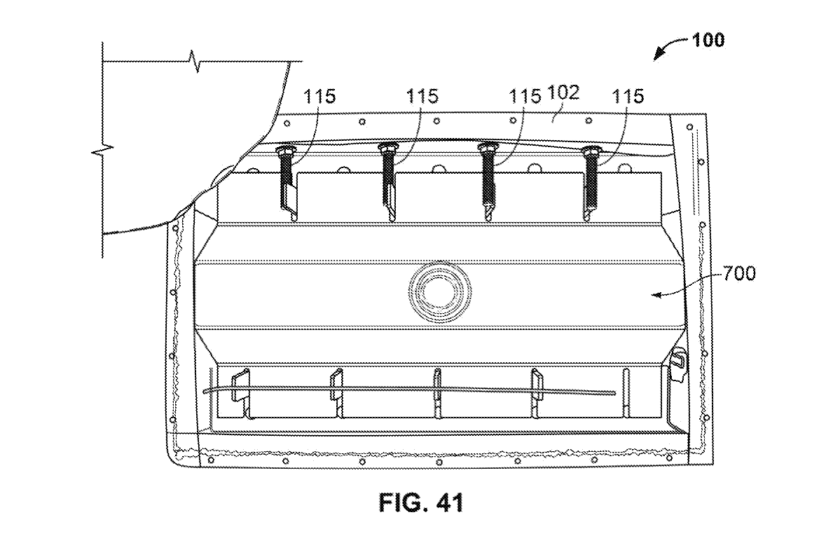

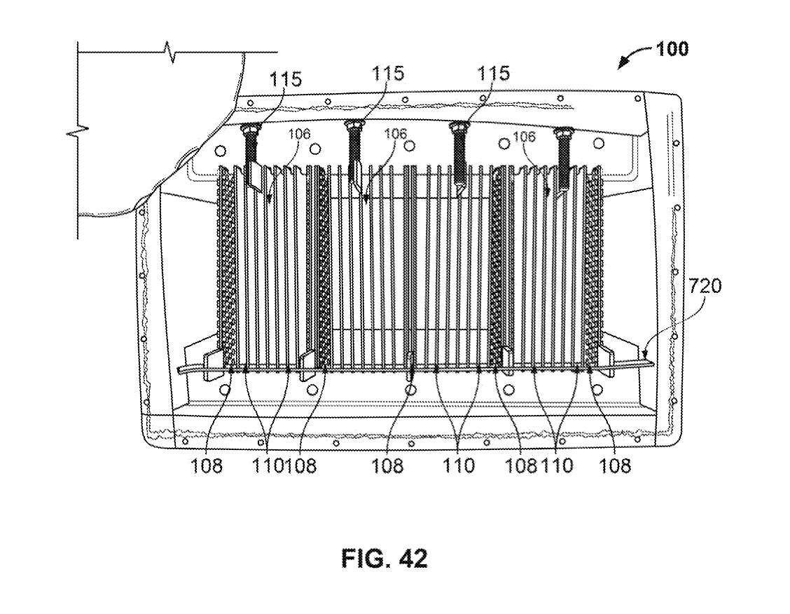

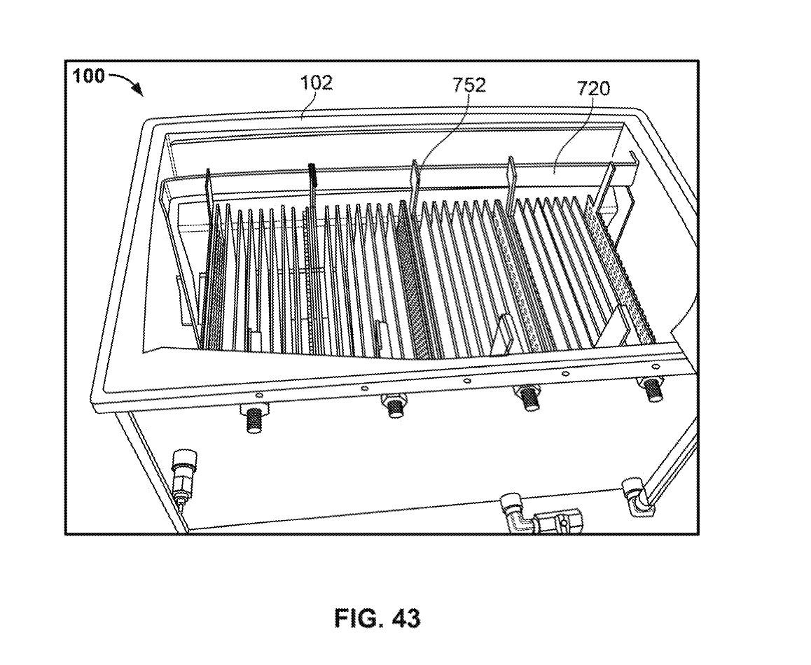

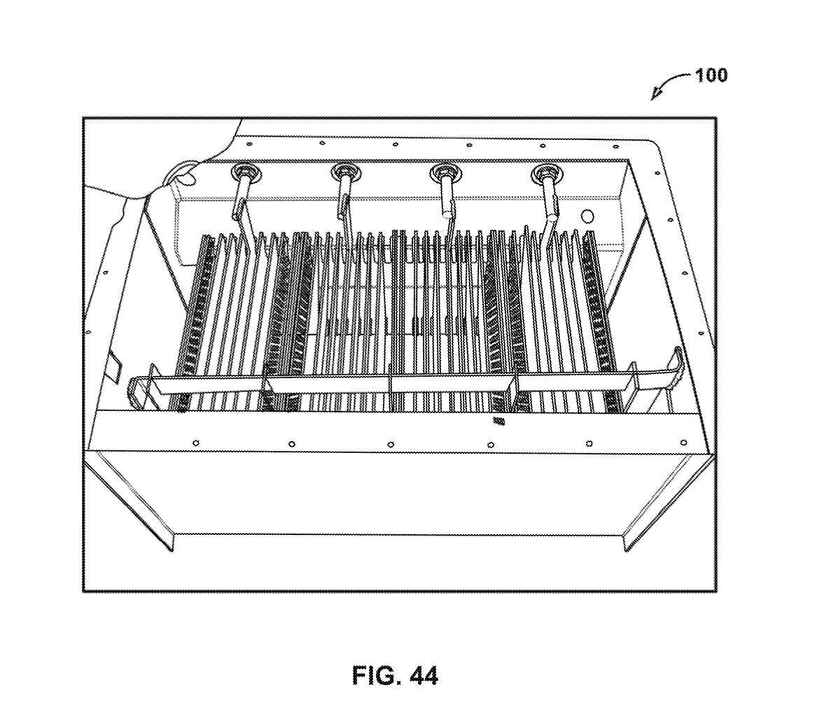

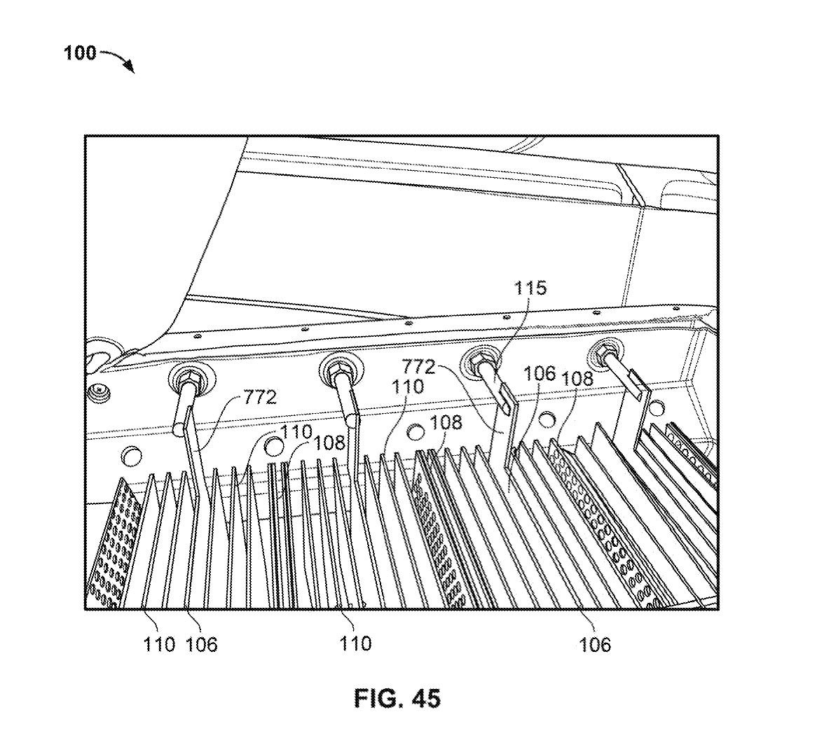

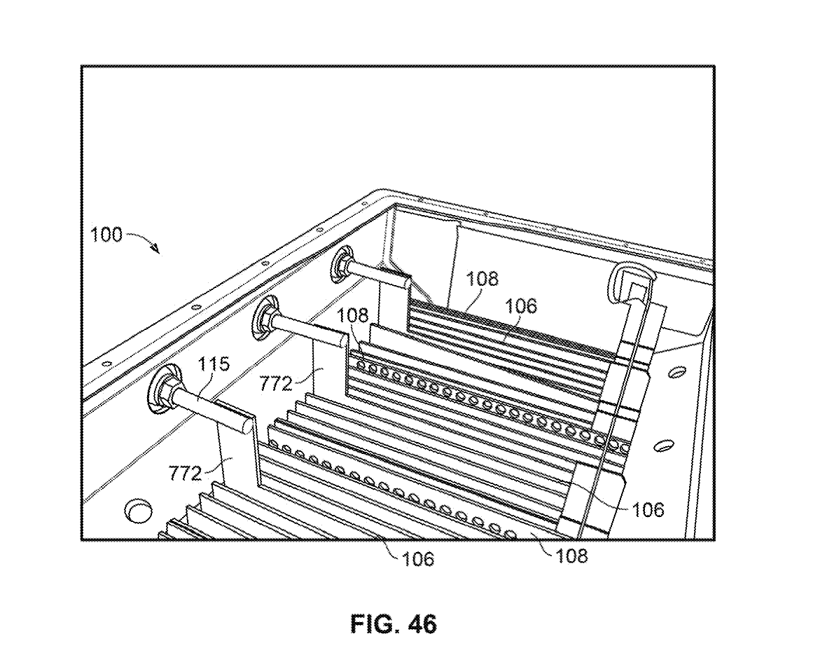

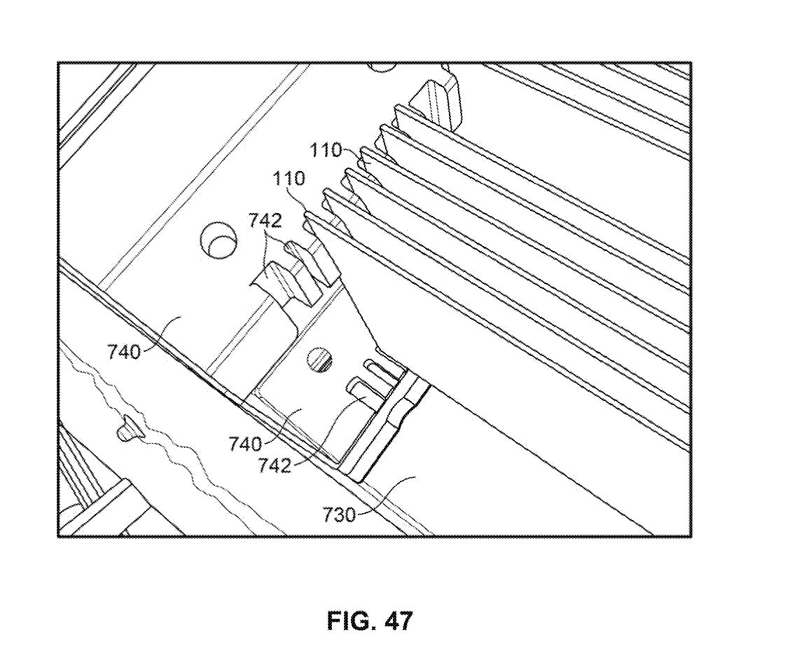

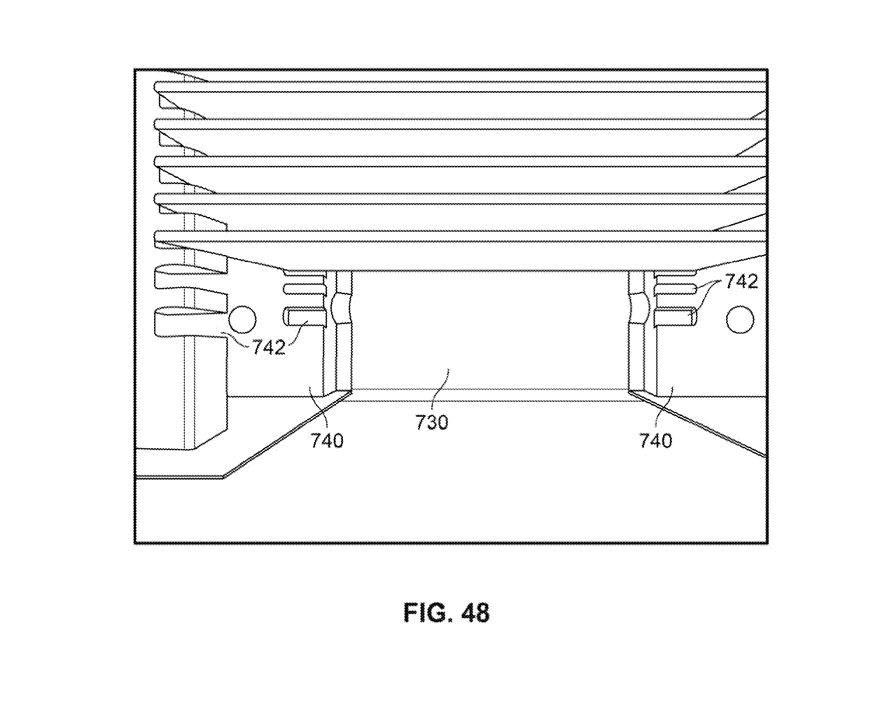

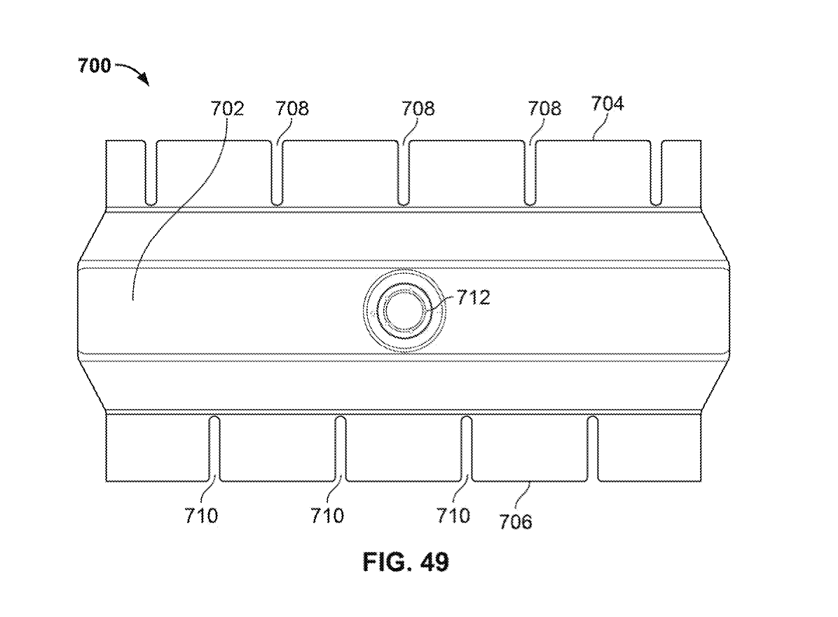

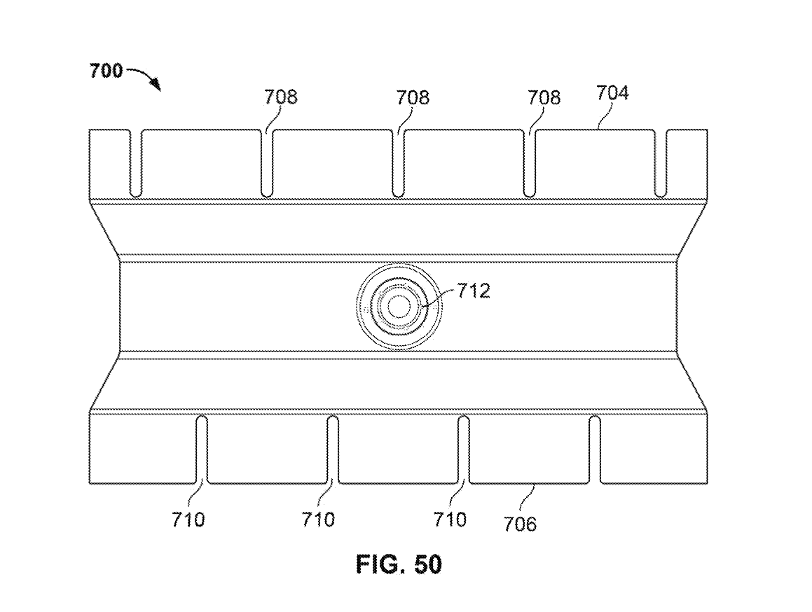

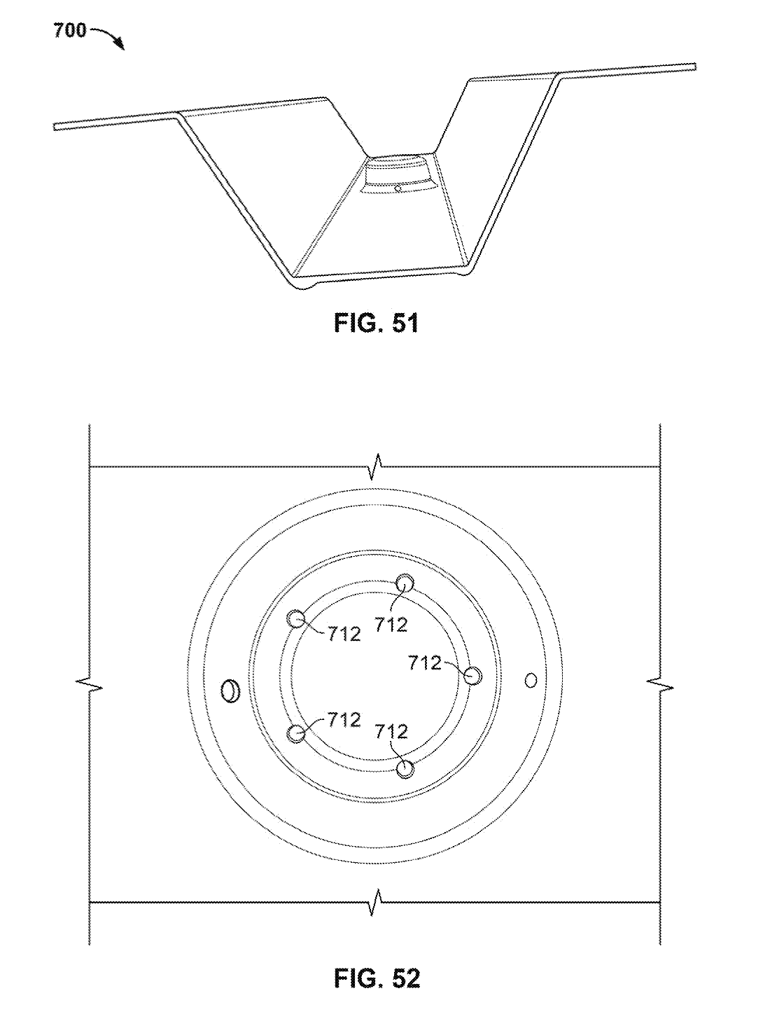

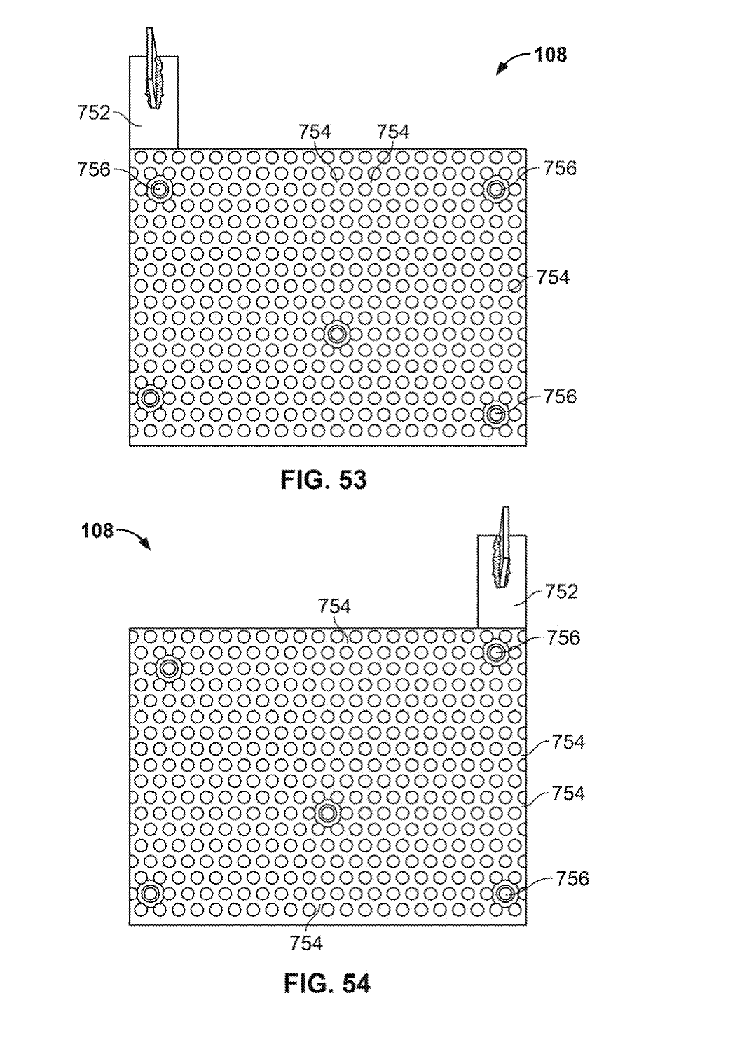

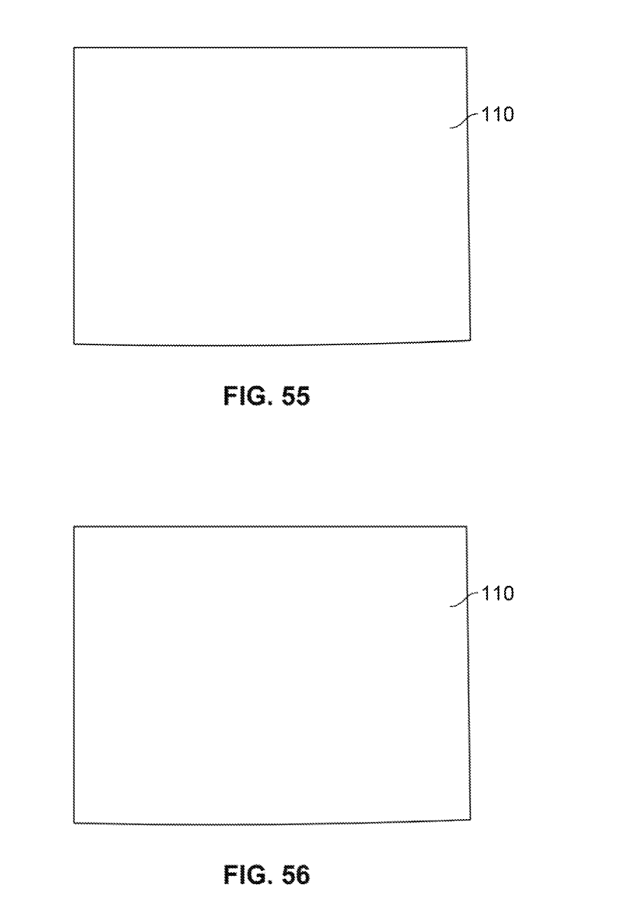

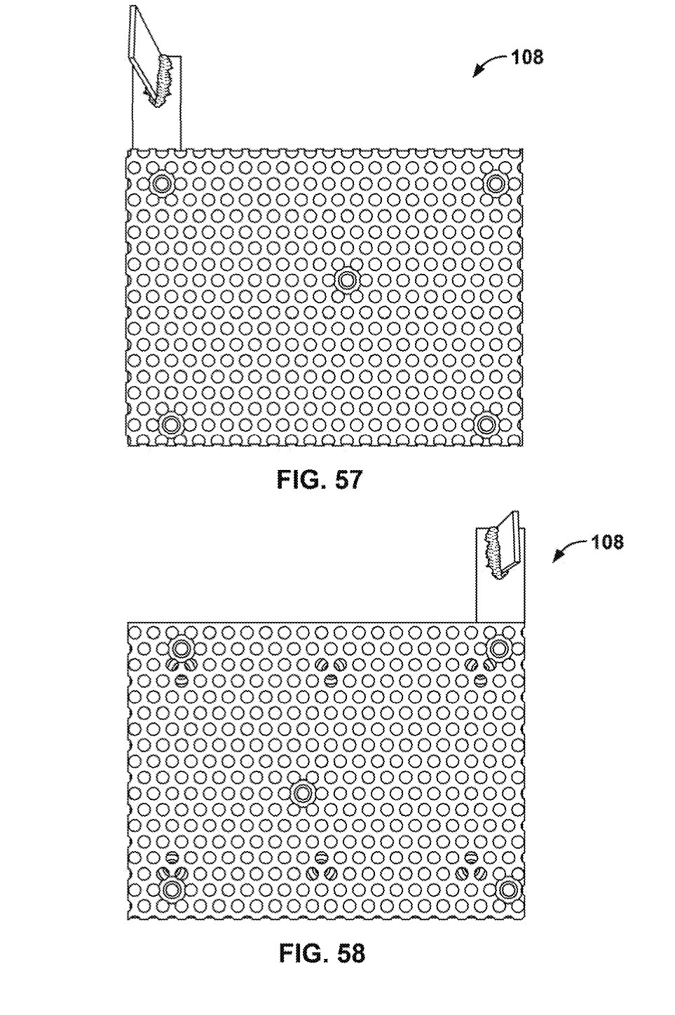

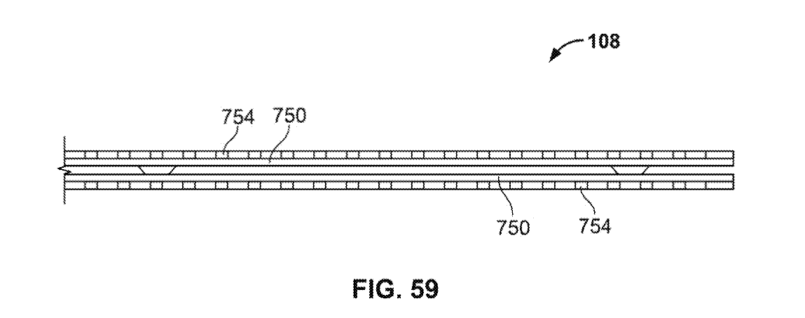

FIGS. 25-59 are pictures of components of another example of a hydrogen generating system of the present disclosure. In the example of FIGS. 25-59, similar parts are given the same reference numerals as in the other examples disclosed above.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a system and method of generating Hydrogen. Although the present examples are described and illustrated herein as being implemented in a internal combustion engine system, the system described is provided as an example and not a limitation. As those skilled in the art will appreciate, the present examples are suitable for application in a variety of different types of systems.

The disclosure of the present application provides various systems and methods for the control of hydrogen generation. For the purposes of promoting an understanding of the principles of the present disclosure, reference will now be made to the examples illustrated in the drawings, and specific language will be used to describe the same. It will nevertheless be understood that no limitation of the scope of this disclosure is thereby intended.

Various systems and methods of hydrogen production disclosed herein are useful to assist internal combustion engines, including but not limited to diesel and gasoline engines, to improve overall fuel efficiency. Hydrogen, as defined in the present disclosure, is intended to be a gas which has a significant percentage of hydrogen as related to other gases. Examples of hydrogen as disclosed herein include, but are not limited to, H2 as well as HHO (commonly known as Brown's gas). In at least one example, hydrogen is produced from distilled water, using a stainless steel plate design.

An increase in fuel efficiency, in at least one example, is accomplished through enrichment of the air that is drawn through the air filters of the combustion engine, thus making it more combustible and doing a better job of igniting the fuel in the combustion chamber. Hydrogen is supplied to the engine along with its normal fuel and air, which results in an increase in efficiency of combustion by about five to about thirty percent. In some instances, the increase in fuel efficiency will be about ten to about thirty percent, or about twenty to about thirty percent. Additionally, combustion of fuel using a hydrogen generating system 100 of the present disclosure emits fewer pollutants into the atmosphere as compared to diesel or gasoline alone. Allowing for nearly 100% burn of fuels, such as petroleum products (i.e. diesel fuel, gasoline, natural gas, and propane) when the combustion engine 300 is used in conjunction with a hydrogen generating system 100 of the present disclosure. The combustion engine 300 according to the disclosure includes, but is not limited to, diesel-powered engines and gasoline-powered engines.

FIG. 1 shows a diagram of at least one example of a hydrogen generating system of the present disclosure mounted on a vehicle. In at least one example of a hydrogen generating system 100 of the present disclosure, as shown in FIG. 1, the hydrogen generating system 100 is contained within a vehicle 50. An exemplary hydrogen generating system 100 is coupled to a bubbler 200 which is then coupled to the air intake 310 of the combustion engine 300 of vehicle 50. Hydrogen gas produced by the hydrogen generating system 100 is directed through the bubbler 200 prior to entering the combustion engine 300 to prevent backflow from a backfire of the combustion engine 300 into the hydrogen generating system 100. The hydrogen generating system 100 is supplied with power from the battery of vehicle 50, or other power source 350. Supply of this power, and the subsequent generation of hydrogen, is controlled by a control system 400 which is able to monitor aspects of the hydrogen generation system 100 (i.e. internal temperature and amperage readings), and the vehicle 50 (including, for example power switch 602, parking break 622, and ignition 620). In addition to monitoring the signals from the hydrogen generation system 100 and vehicle 50, the control system 400 is able to activate a temperature reducing device 500 (such as a fan) and adjust the current feed to the hydrogen generation system up or down based on the temperature inside the hydrogen generating system 100, the level of amperage of the electrodes, and the ignition status of the vehicle 50.

FIG. 2 shows a front planar view of at least one example of a hydrogen generating system of the present disclosure. An exemplary hydrogen generating system 100 of the present disclosure, as shown in FIG. 2, comprises a container 102 and at least one hydrogen generating cell 104 positioned within the container 102. Each hydrogen generating cell 104, in at least one example, comprises a positive electrode 106, a negative electrode 108, and at least one neutral material 110 positioned between the positive electrode 106 and the negative electrode 108. The system further comprises a liquid 112 positioned within the container 102, wherein the liquid 112 contacts the positive electrode 106, the negative electrode 108, and the at least one neutral material 110. An exemplary hydrogen generating system 100 further comprises a power source 350 operably coupled to the positive electrode 106 of at least one hydrogen generating cell 104, wherein the power source 350 is operable to provide a current to the positive electrode 106. The current from the power source 350 is provided to the positive electrode 106 at electrode connector 351, where the at least one hydrogen generating cell 104 releases hydrogen through electrolysis. The positive electrode 106 and negative electrode 108, in at least one example of the hydrogen generating system 100, have a significantly planar shape. Moreover, the positive electrode 106, negative electrode 108, and neutral material 110 in at least one example, are comprised of a conductive material. The conductive material in at least one example is steel.

In at least one exemplary example of the hydrogen generating system 100 of the present disclosure, the liquid 112 comprises water. The liquid 112, in at least one example, may further comprise potassium hydroxide. The level of potassium hydroxide present in at least one example may be at a concentration of about 0.05% v/v to about 0.3% v/v. In a further example, the potassium hydroxide is at a concentration of about 0.1% v/v to about 0.22% v/v. In at least one example, the liquid 112 may further comprise ethylene glycol.

The container 102, in at least one example, is airtight and watertight. Further, in at least one example, the container 102 is comprised substantially of a non-reactive material. Additionally, the container 102, in at least one example, is comprised substantially of stainless steel.

In at least one example of a hydrogen generating system 100 of the present disclosure, the hydrogen generating cell 104 is comprised of a plate that will be connected to the positive terminal of a power source 350, two plates that will be connected to the negative terminal of a power source 350, and several neutral plates positioned between the positive and negative plates. In at least one example, the power source 350 connected to the positive and negative plates comprise a 12 volt battery. In at least one example of the hydrogen generating cell 104, the plate size and placement of the plates within the cell 104 will determine the amount of hydrogen produced. According to at least one example of the hydrogen generating cell 104 of the present disclosure, the cell 104 is comprised of two negative, one positive and six neutral plates, whereby three neutral plates are positioned on each side of the positive plate, noting that each cell has one positive plate. In at least one example, the negative plates are double plates with ⅛ inch spacing there between. In at least one example, the plates are insulated from each other, and spacing is present between the sides of the container 102 and the plates. An insulative material 111, in at least one example may be positioned between the walls of the container 102 and the plates to diminish electrical transfer between the container 102 and the positive electrode 106. Further, in at least one example, the plates may be sealably enclosed within the container 102.

FIG. 3 shows a front perspective view of at least one example of a hydrogen generating system of the present disclosure. As shown, the container 102, according to at least one example, further comprises a gas valve 114 coupled to valve tube 116 to allow the flow of gas from within the container 102 through a valve tube 116. According to at least one example, a container 102 containing three hydrogen generating cells 104 may produce enough hydrogen to allow for a fuel economy increase of about 3% to about 45% for a diesel semi tractor. In an additional example, a container 102 containing three hydrogen generating cells 104 may produce enough hydrogen to allow for a fuel economy increase of about 20, to about 30 percent for a diesel semi tractor. In at least one example, the hydrogen output is fed to the air intake 310 of the combustion engine 300. Further, in at least one example, hydrogen produced from the hydrogen generating system 100 is shunted through a bubbler 200 to prevent any possibility of a flash back from an engine backfire. The liquid 112 within the container 102, in at least one example, comprises distilled water with a teaspoon of potassium hydroxide (estimated to be 10 g). In at least one example, unaltered tap water can be used as the liquid 112. The liquid 112 may be added in feeder valve 113 in at least one example. In addition, current from power source 350 may be supplied to positive electrode 106 by way of the lead connection 115.

The container 102, in at least one example of the hydrogen generating system 100 of the present disclosure, further comprises a liquid gauge 118 coupled to the container 102, where the liquid gauge 118 is operable to measure the volume of the liquid 112 within the container 102. In at least one example, the container 102 further comprises a temperature sensor 120 coupled thereto, where the temperature sensor 120 is operable to determine a temperature within the container 102. In an additional example of the container 102, the container 102 further comprises a release valve 122 coupled thereto, where the release valve 122 is operable to release the liquid 112 from the container 102. The container 102, in at least one example, further comprises a gas valve 114 coupled thereto, where the gas valve 114 is operable to allow hydrogen to flow from within the container 102.

FIG. 4 shows a front perspective view of at least one example of a combustion engine of the present disclosure. Turning to FIG. 4, in at least one example of a hydrogen generating system 100 of the present disclosure, the system 100 further comprises a combustion engine 300 coupled to the container 102, where the combustion engine 300 is capable of receiving hydrogen generated by the hydrogen generating system 100. The hydrogen delivered to the internal combustion engine 300, in at least an example, is operable to increase the combustion efficiency of petroleum 312 positioned within the combustion engine 300.

In at least one example of a hydrogen generating system 100, a gas valve 114 is operably connected to a bubbler 200, and the bubbler 200 is operable to prevent the reverse flow of a gas to the container 102. The bubbler 200, in at least one example, is operably connected to the gas valve 114 by a valve tube 116. In an additional example the bubbler 200 is operably connected to a feeder hose 210, wherein the feeder hose 210 is operable to channel hydrogen from the bubbler 200. In an additional example, the hydrogen generating system 100 further comprises a combustion engine 300 coupled to the feeder hose 210, wherein the feeder hose 210 is operable to deliver hydrogen to the combustion engine 300 from the at least one hydrogen generating cell 104. The hydrogen delivered to the internal combustion engine 300 is operable to increase the combustion efficiency of petroleum 312 positioned within the combustion engine 300. In at least one example, the combustion engine 300 further comprises a combustion chamber 320, where the combustion chamber 320 is operable to receive the hydrogen and the petroleum 312. Petroleum 312 according to the present disclosure includes volatile compounds derived from petroleum. According to at least one example, petroleum 312 may be comprised of diesel fuel, gasoline, CNG, LNG, Natural Gas, Propane, Ethanol, Bio-Fuel, etc.

In at least one example of a hydrogen generating system 100 of the present disclosure, the system comprises a combustion engine 300 having an air intake 310, and a hydrogen generating device comprising a container 102 and at least one hydrogen generating cell 104 positioned within the container 102. Each hydrogen generating cell 104 may comprise various components as referenced herein.

An exemplary hydrogen generating system 100 of the present disclosure further comprises a power source 350 operably coupled to the positive electrode 106 of at least one hydrogen generating cell 104, wherein the power source 350 is operable to provide a current to the positive electrode 106. Furthermore, a gas transfer device may be coupled to the container 102 and the air intake 310, wherein when the current from the power source 350 is provided to the positive electrode 106, the hydrogen generating system 100 releases hydrogen through electrolysis.

FIGS. 25-59 are pictures of components of another example of a hydrogen generating system of the present disclosure. In at least one example of hydrogen generating system 100, as depicted in FIGS. 25-59, the system further comprises insulated material 111, a retaining bar 720, and a splash guard 700. Insulated material 111 comprises an insulated flooring 730 and an insulated holding mechanism 740, which has a plurality of retaining slots 742. Individual slots of the plurality of retaining slots 742 of insulated holding mechanism 740 are sized and shaped so as to allow entry of an individual positive electrode 106, negative electrode 108 or neutral material 110, and to avoid physical contact between any of said electrodes and neutral materials. Insulated material 111, in at least one example, is comprised of a rigid polymer, such as acrylonitrile butadiene styrene. The retaining bar 720 is fixedly attached to each of the negative electrodes 108 and to the container 102 so as to substantially prevent movement of the negative electrodes 108. Further, the retaining bar is positioned relative to the neutral material 110 so as to restrain the movement of said material 110. The splash guard 700 is positioned substantially above the positive electrode 106, negative electrode 108, and neutral material 110, and is operable to impede the movement of liquid 112 into gas valve 114. In at least one example, the splash guard is comprised of a rigid polymer, such as acrylonitrile butadiene styrene.

According to an exemplary example of a hydrogen generating system 100, as depicted in FIGS. 25-59, negative electrode 108 comprises a solid negative plate 750 having a negative electrode arm 752. The solid negative plate 750 is fixedly attached to at least one perforated negative plate 754 by way of a negative plate connection 756. In at least one example, the negative plate connection 756 is a weld. Neutral material 110 comprises three conductive plates positioned between positive electrode 106 and negative electrode 108. Finally, positive electrode 106 comprises a solid positive plate 770 having a positive electrode arm 772. The positive electrode arm 772 is connected to lead connection 115. In at least one example of the connection 115, the connection 115 is a weld.

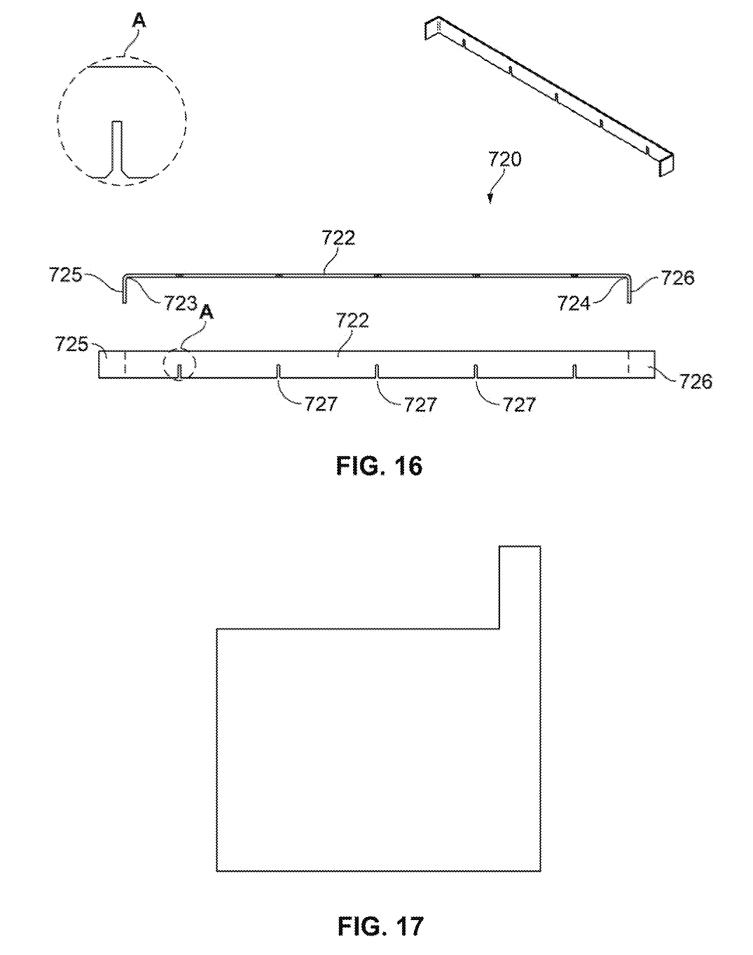

According to an exemplary example of retaining bar 720, as seen in FIGS. 16 and 25-59, the retaining bar 720 is a rectangular and substantially flat piece of conductive material that has a middle portion 722, a first bend 723, and a second bend 724, whereby the first bend 723 and second bend 724 define a first end 725 and second end 726 respectively. The first end 725 and second end 726 are each substantially perpendicular to the middle portion 722. Further, the retaining bar 720 comprises a plurality of securing notches 727 on one face of the middle portion 722, each of which are operable to receive a portion of the negative electrode arm 752. First end 725 and second end 726 are each fixed and electrically coupled to the container 102. In at least one example, the electrical coupling between first end 725 and second end 726 with container 102 is accomplished through a weld.

According to an exemplary example of the splash guard 700, as depicted in FIGS. 25-59, splash guard 700 has a bridge region 702, a first splash guard arm 704, and a second splash guard arm 706, where the first splash guard arm 704, and a second splash guard arm 706 are connected to opposite edges of the bridge region 702. The bridge region 702 is structured to define a series of voids 712 which are operable for movement of hydrogen there through. The first splash guard arm 704 has a plurality of negative electrode notches 708, where each positive notch 708 is sized and shaped to allow a positive electrode arm to receive a portion of a positive electrode arm 772. The second splash guard arm 706 has a plurality of negative electrode notches 710, where each positive electrode notch 710 is sized and shaped to receive a portion of a negative electrode arm 752.

According to at least one example of hydrogen generating system 100, as depicted in FIGS. 25-59, positive electrode 106, negative electrode 108, neutral material 110, retaining bar 720, and container 102 are made of an electrically conductive metal. According to an exemplary example of the hydrogen generating system, positive electrode 106, negative electrode 108, neutral material 110, and retaining bar 720 are comprised of 316L stainless steel, and container 102 is comprised of 304 stainless steel.

FIG. 5 shows a front planar view of at least one example of a control system of the present disclosure. In at least one example of a hydrogen generating system 100 of the present disclosure, the system 100 further comprises a processor 410 as depicted in FIG. 5, wherein the processor 410 is operably coupled to a power source 350 and the hydrogen generating device. The processor 410 is operable to receive at least one signal from the hydrogen generating system 100. In a further example the processor 410 is operable to deliver a current to the hydrogen generating system 100, whereby the current triggers the production of hydrogen gas by the hydrogen generating system 100. In at least one additional example, the processor 410 is operable to control the current delivered to the hydrogen generating system 100 in response to the at least one signal from the hydrogen generating system 100. The processor 410, according to at least one example, is resistant to vibration, and/or liquid 112 contact. In at least one additional example a hydrogen generating system 100 of the present disclosure, the processor 410 is encased in a resistant material 512 for protection. The resistant material 512, according to an example, is selected from a group consisting of epoxy, silicon, polyurethane, or a resin.

In an exemplary example of a processor 410 according to the present disclosure, the processor 410 is coupled to a vehicle 50, and a hydrogen generating system 100. The processor 410 is operable to receive inputs from an ignition switch 620 of a vehicle 50, a power switch 602 of a manual control 600, a parking signal 622 of the vehicle 50, and a temperature sensor 120 of the hydrogen generating system 100. From these inputs, the processor 410 is operable to display the status of the hydrogen generating system 100 to a manual control 600, initiate a temperature reducing device 500 to lower the temperature inside the container 102 of the hydrogen generating system 100, and selectively supply current to one or more of the hydrogen generating cells 104.

FIG. 6 shows a flowchart of at least one-example of a method for producing hydrogen of the present disclosure. In at least one exemplary example of a method of producing hydrogen of the present disclosure, as depicted in FIG. 6, the method 1000 comprises the step 1002 of coupling a hydrogen generating system 100 to a combustion engine 300, the step 1004 of operating the hydrogen generating system 100 to generate hydrogen through electrolysis, and the step 1006 of supplying the hydrogen to a gas transfer device 230 operably coupled to a combustion engine 300 for use with the combustion engine 300.

An exemplary method of producing hydrogen 1000 of the present disclosure further includes the step of providing 1008 a control system 400 comprising a processor 410 connected to a power source 350 and a hydrogen generating system 100. Moreover, the method 1000 may also comprise the step of introducing 1010 the current from the power source 350 to the positive electrode 106 wherein when the current from the power source 350 is introduced the at least one hydrogen generating cell 104 thereby releasing hydrogen through electrolysis. The hydrogen is then supplied to a gas transfer device operably coupled to a combustion engine 300 for use with the combustion engine 300.

In at least one example of a method of producing hydrogen 1000 of the present disclosure, the method 1000 further comprises the step 1012 of combusting the hydrogen with a petroleum based substance such as gasoline diesel fuel or the like 312 to increase a combustion efficiency of the petroleum 312.

An exemplary method of producing hydrogen 1000, according to at least one example of the present disclosure, further comprises the step of monitoring 1014 a temperature within the container 102, wherein the processor 410 is operable to monitor the temperature within the container 102. Additionally, in at least one example, the method 1000 further comprises the step of operating 1016 a temperature reducing device 500 positioned at or near the hydrogen generating system 100, whereby the temperature reducing device 500 operable to lower the temperature within the container 102.

In at least one example of the method of producing hydrogen according to the present disclosure, the method further comprises the step 1018 of causing the processor 410 to start the temperature reduction device 500 upon monitoring a temperature within the container 102 at or above a set temperature, wherein the temperature reduction device 500 lowers the temperature within the container 102. The method of producing hydrogen may further comprise in at least one example, the step of monitoring 1020 the amperage of the at least one hydrogen generating cell 104, wherein the controller is operable to monitor the amperage of the at least one hydrogen generating cell 104.

In at least one example of the method of generating hydrogen 1000 of the present disclosure, the method further comprises the step of adjusting 1022 the current to at least one hydrogen generating cell 104 upon the temperature of the container 102 meeting or exceeding the set temperature, and/or the positive electrode 106 meeting or exceeding a set amperage. In at least one example, the method 1000 further comprises the step of halting 1024 the current to at least one hydrogen generating cell 104 upon the temperature of the container 102 meeting or exceeding the set temperature.

According to at least one example of a method of generating hydrogen of the present disclosure, the at least one hydrogen generating cell 104 comprises two or more hydrogen generating cells 104. In at least one example, the method 1000 further comprises the step of cycling 1026 the current between cells present in the at least one hydrogen generating cell 104 upon the temperature of the container 102 meeting or exceeding the set temperature.

An exemplary method of producing hydrogen 1000, according to at least one example of the present disclosure, further comprises the step of increasing 1028 the current to at least one hydrogen generating cell 104 upon the temperature of the container 102 reading at or below a second set temperature. The second set temperature, in at least one example, is about 105° F. to about 115° F. In at least one example of the method, the second set temperature is about 110° F.

An exemplary method of producing hydrogen 1000 according to at least one example, further comprises the step of testing 1030 the at least one hydrogen generating cell 104 for a short circuit and the step of adjusting 1032 the current to at least one hydrogen generating cell 104 upon detecting the short circuit.

FIG. 4 depicts at least one example of the control system 400 of the present disclosure, the control system 400 comprising a processor 410 operably connected to a power source 350 and a hydrogen generating system 100. The processor 410, in at least one example comprises a series of inputs and outputs for the control of hydrogen generation. The inputs may include a battery lug 412, a ground connector 414, a temperature sensor connector 416, an ignition connector 418, a power switch connector 420, and a parking signal connector 422. The outputs from an exemplary processor 410 may include a cooling mechanism connector 424, a status indicator, a first electrode connector 428, a second electrode connector 430, a third electrode connector 432, and a fourth electrode connector 434.

In at least one example, the control system 400 regulates the production of hydrogen to be supplied to the combustion engine 300. By monitoring and balancing the internal tank temperature and the current draw of the electrodes, the control system 400 works to provide optimal hydrogen production. If there is not sufficient air flow to keep the tank cool, the control system 400 activates the temperature reducing device 500 to provide additional cooling. If the tank temperature continues to increase the control system 400 may further regulate the temperature through limiting the current draw of the electrodes until a controllable balance is achieved. The control system 400 may also reduce the current draw of the electrodes, reducing the hydrogen production if it determines excess hydrogen is being produced.

The battery connector 412, according to at least one example and as identified in FIG. 5 and FIGS. 7-9 as a red 6 gauge wire, is connected to vehicle 50, +12 VDC battery through a circuit breaker. In at least one example the current for the electrodes and temperature reducing device 500 is provided by this input.

The ground connector 414 according to at least one example and as identified as a 14 gauge black wire in FIGS. 7-9, connects the processor 410 to the hydrogen generating system 100. This ground connector 414 provides ground to the processor 410, the temperature reducing device 500 and the temperature sensor 120. The hydrogen generating system 100 itself is grounded to the chassis and/or back to the power source 350. The ground path for the electrodes is through the metal tank, requiring the tank to be grounded.

The temperature sensor 120, according to at least one example and as identified as a 16 gauge green wire in FIGS. 7-9 connects the temperature sensor 120 mounted on the container 102 with the processor 410. This input from the temperature sensor 120 is used to monitor the internal temperature of the hydrogen generating system 100.

FIG. 7 shows an electrical diagram of at least one example of a control system of the present disclosure. FIG. 8 shows a front planar view of at least one example of a control system of the present disclosure. FIG. 9 shows a planar view of at least one example of a control system of the present disclosure. In at least one example of the ignition connector 418, as identified as a 16 gauge orange wire in FIGS. 7-9, the ignition connector 418 couples the ignition switch 620 or a circuit that has +12 VDC on it when the ignition key is in the ON position. For the control system 400 to work both the ignition 620 and power switch 602 inputs must have +12 VDC provided. If the power ceases to either input, the module turns off.

In at least one example of the power switch 602, connector as identified as a 16 gauge white wire in FIGS. 7-9, the power switch 602 connector couples the +12 VDC power switch 602 to the processor 410. The power switch 602 may be used to turn the hydrogen generating system 100 on/off at the driver's control. For the control module to work both the Ignition and Power switch 602 inputs must have +12 VDC on them. If either input is off, the module turns off.

In at least one example of the parking signal ground connector 414 as identified as a 16 gauge purple wire in FIGS. 7-9, the parking signal ground connector 414 connects the parking brake solenoid 622 or other device that provides a ground signal when the vehicle 50 is in park or the park brake is set. This signal is used to indicate that a vehicle 50 has parked, and therefore has a lower demand for hydrogen. The module reduces the hydrogen generator output to one electrode while the parking signal 622 is present.

The temperature reducing device connector 424,111 at least one example and as identified as a 14 gauge blue wire in FIGS. 7-9, connects the processor 410 to a temperature reducing device 500 mounted on the container 102 of the hydrogen generating system 100. In an exemplary example, if the internal container 102 temperature reaches 120° F., the temperature reducing device 500 will turn on and stay on until the temperature of container 102 drops to 110° F. or below.

In at least one example of the status indicator connector 426 as identified as a 16 gauge yellow wire in FIGS. 7-9, the status indicator connector 426 couples the status indicator to the processor 410. The status indicator will be on whenever at least one hydrogen generating cell 104 is on, and is used as an indicator that the system 100 is producing hydrogen.

In at least one example of the first electrode connector 428 as identified as a 12 gauge yellow wire in FIGS. 7-9, the connector 428 couples the processor 410 to the first positive electrode 106-1 on the hydrogen generating system 100. In an exemplary example, the system 100 will optionally test the electrode to determine if it is functional upon receiving power. If it is determined that the electrode is not operational the electrode will not be used. The remaining electrodes that tested operational will continue to be used to produce hydrogen.

In at least one example of the second electrode connector 430 as identified as a 12 gauge white wire in FIGS. 7-9, the connector 430 couples the processor 410 to the second positive electrode 106-2 on the hydrogen generating system 100. In an exemplary example, the system 100 will optionally test the electrode to determine if it is functional upon receiving power. If it is determined that the electrode is not operational the electrode will not be used. The remaining electrodes that tested operational will continue to he used to produce hydrogen. According to at least one example, the third electrode connector 432, as identified as a 12 gauge orange wire in FIGS. 7-9, couples the processor 410 to the third positive electrode 106-3 on the hydrogen generating system 100. According to at least one additional example, the fourth electrode connector 434, as identified as a 12 gauge brown wire in FIGS. 6, 7, and 8 couples the processor 410 to the fourth positive electrode 106-4 on the hydrogen generating system 100.

In at least an example of the control system 400 of the present disclosure the processor 410 is operably connected to a ground element. The processor 410, in at least one example, may be operably connected to a power switch 602. The power switch 602, according to at least one example, comprises a cut off switch, which is operable to alter the flow of the current to the hydrogen generating system 100. Further, according to at least one example, the power switch 602 further comprises at least one indicator operable to display at least one performance variable.

In at least one exemplary example of the hydrogen generating system 100 of the present disclosure, the system 100 further comprises a temperature reducing device 500 operably connected to a processor 410. The temperature reducing device, according to at least one example of the control system 400, may be selected from a group consisting of a fan, a refrigeration device, a jacketed coolant system, or connection to a coolant mechanism inherent to a vehicle 50 to which the device is mounted.

The hydrogen generating system 100 according to at least one example, further comprises a temperature sensor 120 operable to determine the internal temperature of the hydrogen generating system 100, the temperature sensor 120 operably connected to the processor 410. According to at least one example of the hydrogen generation system, the processor 410 is operable to activate a temperature reduction device if the temperature sensor 120 meets or exceeds a set temperature. The set temperature, according to at least one example, is about 120° F. to about 200° F. Further the set temperature, according to at least one example, is about 140° F. to about 200° F. The hydrogen generating system 100 according to at least one example further comprises a computer, whereby the computer is operable to define a set temperature.

According to at least one example, the processor 410 of the hydrogen generating system 100 is operably connected to a vehicle 50, wherein the vehicle 50 comprises an ignition mechanism 620, a power input 602, and a parking sensor 622. In at least one example of the hydrogen generating system 100, the processor 410 is operable to alter the flow of electrical current to the hydrogen generating system 100 in response to an ignition signal from the ignition mechanism 620.

The processor 410, according to at least one example of the hydrogen generating system 100, delays the introduction of electrical current to the hydrogen generating system 100 for a fixed time following recognition of the ignition signal. The fixed time, according to at least one example, is between about two minutes and about five minutes. Further, according to at least one example of the present disclosure, the fixed time is between about three minutes and about four minutes.

In at least one example of the hydrogen generating system 100, the processor 410 can alter the flow of electrical current to the hydrogen generating system 100 in response to a power signal from the power input 602. Further, according to an additional example, the processor 410 can alter the flow of electrical current to the hydrogen generating system 100 in response to a parking signal 622 from the parking sensor.

The various devices, systems, and methods for generation of hydrogen of the present disclosure have various benefits to the operation of combustion engines 300 and the emissions thereof. For example, the incomplete combustion of petroleum 312 in combustion engines 300 may lead to both emission of pollutants, as well as lowered fuel efficiency.

While various examples of systems, and methods for the generation of hydrogen, have been described in considerable detail herein, the examples are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative examples, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the spirit and scope of the present disclosure.

Those skilled in the art will realize that the process sequences described above may be equivalently performed in any order to achieve a desired result. Also, sub-processes may typically be omitted as desired without taking away from the overall functionality of the processes described above.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The devices, systems, and methods for producing hydrogen of the present disclosure may include one or more of the following elements, features, limitations, and/or steps, either alone or in combination with one another: a hydrogen generating system. At least one hydrogen generating cell, the hydrogen generating cell comprising a positive electrode, a negative electrode, at least one neutral material positioned between the positive electrode and the negative electrode; and a liquid, the liquid contacting the positive electrode, the negative electrode, and the at least one neutral material. A container; a container, wherein the at least one hydrogen generating cell is disposed within the container; a power source operably connected to the positive electrode, wherein the application of an electrical current from the power source to the positive electrode releases hydrogen from the liquid. A liquid comprising water: the liquid further comprises potassium hydroxide, wherein the potassium hydroxide is at a concentration of about 0.05° % v/v to about 0.3% v/v: wherein the potassium hydroxide is at a concentration of about 0.1% to about 0.22% v/v; the liquid further comprising ethylene glycol; the container further comprises a liquid gauge connected to the container. The container further comprises a temperature sensor operable to determine the temperature within the container. The container further comprises a release valve operable to drain the liquid from the container. The container further comprises a gas valve operable to release hydrogen from within the container. A bubbler, wherein the gas valve is operably connected to a bubbler, the bubbler operable to prevent the reverse flow of a gas to the container. The bubbler is operably connected to the gas valve by a first tube, bubbler is operably connected to a feeder hose; an engine; an internal combustion engine, the internal combustion engine having an air intake. A gas transfer device coupled to the container and the air intake; a processor; wherein the processor operably connected to a processor: a power supply operably connected to the processor. The processor is operable to receive at least one signal from a hydrogen generating system. The processor operable to deliver an electrical current to the hydrogen generating system, wherein the electrical current triggers the production of hydrogen by the hydrogen generating system, wherein the processor is operable to control the electrical current delivered by the processor to the hydrogen generating system in response to the at least one signal from the hydrogen generating system. Providing a hydrogen generating system, introducing electrical current by the power source to the positive electrode; directing the hydrogen produced by introduction of electrical current to the positive electrode to a gas transfer device. Providing an internal combustion engine operably connected to the a gas transfer device, wherein the gas transfer device further comprises a bubbler operable to prevent the reverse flow of a gas to the container, wherein the internal combustion engine is a diesel engine. Monitoring the temperature within the container, wherein the control mechanism is operable to monitor the temperature within the container. Providing a fan, the fan operably connected to a control mechanism. Causing the control mechanism to start the fan upon reaching a set temperature reading, wherein the tan lowers the temperature within the container. Monitoring the amperage of the positive electrode and negative electrode, wherein the control mechanism is operable to monitor the amperage of the positive electrode and negative electrode. Adjusting the current to at least one hydrogen generating cell upon the temperature of then container reaching the set temperature reading, and the positive electrode having a set amperage reading. Increasing the current to at least one hydrogen generating cell upon the temperature of then container reading below a second set temperature. Testing the positive electrode and negative electrode for a short circuit. Adjusting the current to at least one hydrogen generating cell upon detecting the short circuit. A processor, the processor operably connected to a control mechanism. A power supply operably connected to the processor, the control mechanism operable to receive at least one signal from a hydrogen generating system, the control mechanism operable to deliver an electrical current to the hydrogen generating system; wherein the electrical current triggers the production of hydrogen by the hydrogen generating system; and the processor operable to control the electrical current delivered by the control mechanism to the hydrogen generating system in response to the at least one signal from the hydrogen generating system, wherein the processor is operably connected to a ground element, wherein the processor is operably connected to a power switch, wherein the power switch comprises a cut off switch the cut off switch operable to alter the flow of electrical current to the hydrogen generating system. Wherein the power switch further comprises at least one indicator switch operable to display at least one performance variable, wherein the hydrogen generating system further comprises a fan, the fan operably connected to the control mechanism, wherein the hydrogen generating system further comprises a temperature sensor operable to determine the internal temperature of the hydrogen generating system the temperature sensor operably connected to the control mechanism. Wherein the processor is operable to activate a fan if the temperature sensor reads a set temperature, the set temperature is 120° F.; wherein the set temperature is 140° F., wherein the hydrogen generating system is operably connected to a power source, the power source operably connected to the control mechanism, wherein the control mechanism is operably connected to a vehicle, the vehicle comprising an ignition mechanism, a power input, and a parking sensor. Wherein the processor can alter the flow of electrical current to the hydrogen generating system in response to an ignition signal from the ignition mechanism. Wherein the processor delays the introduction of electrical current to the hydrogen generating system for a fixed time following recognition of the ignition signal, the fixed time is three minutes, wherein the processor can alter the flow of electrical current to the hydrogen generating system in response to an power signal from the power input, wherein the processor can alter the flow of electrical current to the hydrogen generating system in response to a parking signal from the parking sensor.

1. A hydrogen generating system comprising:
a container;
at least one hydrogen generating cell positioned within the container, each hydrogen generating cell including:
a positive electrode,
a negative electrode, and
at least one neutral material positioned between the positive electrode
and the negative electrode;
a liquid positioned within the container, the liquid contacting the positive electrode, the negative electrode, and the at least one neutral material; and
a power source operably coupled to the positive electrode of at least one hydrogen generating cell, the power source operable to provide a current to the positive electrode;
wherein when the current from the power source is provided to the positive electrode, the at least one hydrogen generating cell releases hydrogen through electrolysis.

2. The system of claim 1, wherein the liquid comprises water.

3. The system of claim 2, wherein the liquid further comprises potassium hydroxide.

4. The system of claim 3, wherein the potassium hydroxide is at a concentration of about 0.05% v/v to about 0.3% v/v.

5. The system of claim 3, wherein the potassium hydroxide is at a concentration of about 0.1% to about 0.22% v/v.

6. The system of claim 3, wherein the liquid further comprises ethylene glycol.

7. The system of claim 1, wherein the container further comprises a liquid gauge coupled to the container, the liquid gauge operable to measure the volume of the liquid within the container.

8. The system of claim 1, wherein the container further comprises a temperature sensor coupled to the container, the temperature sensor operable to determine a temperature within the container.

9. The system of claim 1, wherein the container further comprises a release valve coupled to the container, the release valve operable to release the liquid from the container.

10. The system of claim 1, further comprising a combustion engine coupled to the container, the combustion engine capable of receiving hydrogen generated by the hydrogen generating system, wherein the hydrogen delivered to the internal combustion engine is operable to increase the combustion efficiency of a petroleum positioned within the combustion engine.

11. The system of claim 1, wherein the container further comprises a gas valve coupled to the container, the gas valve operable to allow hydrogen to flow from within the container.

12. The system of claim 11, wherein the gas valve is operably connected to a bubbler, the bubbler operable to prevent the reverse flow of a gas to the container.

13. The system of claim 12, wherein the bubbler is operably connected to the gas valve by a valve tube.

14. The system of claim 12, wherein the bubbler is operably connected to a feeder hose, the feeder hose operable to channel hydrogen from the bubbler.

15. The system of claim 14, further comprising a combustion engine coupled to the feeder hose, wherein the feeder hose is operable to deliver hydrogen to the combustion engine from the at least one hydrogen generating cell.

16. The system of claim 15, wherein the hydrogen delivered to the internal combustion engine is operable to increase the combustion efficiency of a petroleum positioned within the combustion engine.

17. The system of claim 16, wherein the internal combustion engine further comprises a combustion chamber, the combustion chamber operable to receive the hydrogen and the petroleum.

18. A hydrogen generating system comprising:
a combustion engine having an air intake;
a hydrogen generating device operably coupled to the combustion engine, the device including:
a container;
at least one hydrogen generating cell positioned within the container, each hydrogen generating cell including:
a positive electrode,
a negative electrode; and
at least one neutral material positioned between the positive electrode and the negative electrode;
a liquid positioned within the container, the liquid contacting the positive electrode, the negative electrode and the at least one neutral material; and
a power source operably coupled to the positive electrode of at least one hydrogen generating cell, the power source operable to provide a current to the positive electrode;
a gas transfer device coupled to the container and the air intake the gas transfer device operable to direct hydrogen; and
a processor coupled to the container, the at least one hydrogen generating cell, and the power source, the processor operable to alter the current to the positive electrode;
wherein when current from the power source is provided to the positive electrode, the at least one hydrogen generating cell releases hydrogen through electrolysis; and
wherein the hydrogen is operable to increase the combustion efficiency of a petroleum positioned within the combustion engine.

19. A hydrogen generating system comprising:
a combustion engine having an air intake;
a hydrogen generating device, the device including;
a container;
at least one hydrogen generating cell positioned within the container, each hydrogen generating cell including:
a positive electrode;
a negative electrode, and
at least one neutral material positioned between the positive electrode and the negative electrode;
a liquid positioned within the container, the liquid contacting the positive electrode, the negative electrode, and the at least one neutral material; and
a power source operably coupled to the positive electrode of at least one hydrogen generating cell, the power source operable to provide a current to the positive electrode; and
a gas transfer device coupled to the container and the air intake;
wherein when the current from the power source is provided to the positive electrode, the at least one hydrogen generating cell releases hydrogen through electrolysis.

20. The system of claim 19, further comprising a processor operably coupled to the power source and the hydrogen generating device, the processor operable to receive at least one signal from the hydrogen generating device.

21. The system of claim 18, whereby the processor is operable to deliver current to then hydrogen generating system, wherein the current triggers the production of hydrogen by the hydrogen generating system.

22. The engine of claim 19, wherein the processor is operable to control the current delivered to the hydrogen generating system in response to the at least one signal from the hydrogen generating system.

23. A method of producing hydrogen comprising:
coupling a hydrogen generating system to a combustion engine;
operating the hydrogen generating system to generate hydrogen through electrolysis; and
supplying the hydrogen to a gas transfer device operably coupled to a combustion engine for use with the combustion engine.

24. The method of claim 23, wherein the hydrogen generating system comprises:
a container;
at least one hydrogen generating cell positioned within the container the at least one hydrogen generating cell including a positive electrode, a negative electrode, at least one neutral material positioned between the positive electrode and the negative electrode, and a liquid, the liquid contacting the positive electrode, the negative electrode, and the at least one neutral material; and
a power source operably connected to the positive electrode.

25. The method of claim 23, wherein the hydrogen generating system comprises a control system, the system including a processor operably connected to the power source, and the at least one hydrogen generating cell, the processor operable to receive at least one signal from the hydrogen generating system, to deliver a current to the hydrogen generating system from the processor, and control the electrical current delivered to the hydrogen generating system in response to the at least one signal from the hydrogen generating system.

26. The method of claim 23, further comprising combusting the hydrogen with a petroleum to increase a combustion efficiency of the petroleum.

27. The method of claim 23, wherein the gas transfer device further comprises a bubbler operable to prevent the reverse flow of a gas to the container.

28. The method of claim 23, wherein the combustion engine is a diesel engine.

29. The method of claim 23, further comprising the monitoring a temperature within the container using the processor.

30. The method of claim 29, further comprising operating a temperature reducing device positioned at or near the hydrogen generating system, the temperature reducing device operable to lower the temperature within the container.

31. The method of claim 30, further comprising the step of causing the processor to start the temperature reduction device upon monitoring an temperature within the container at or above a set temperature, wherein the temperature reduction device lowers the temperature within the container.

32. The method of claim 31 further comprising the step of monitoring the amperage of the at least one hydrogen generating cell, wherein the processor is operable to monitor the amperage of the at least one hydrogen generating cell.

33. The method of claim 32, further comprising the step of adjusting the current to at least one hydrogen generating cell upon the temperature of the container meeting or exceeding the set temperature.

34. The method of claim 32, further comprising the step of adjusting the current to at least one hydrogen generating cell upon the positive electrode meeting or exceeding a set amperage.

35. The method of claim 33, further comprising the step of increasing the current to at least one hydrogen generating cell upon the temperature of the container reading below a second set temperature.

36. The method of claim 24, further comprising:
testing the at least one hydrogen generating cell for a short circuit; and
adjusting the current to at least one hydrogen generating cell upon detecting the short circuit.

37. A control system for a hydrogen generating system comprising:
a processor;
a power source coupled to the processor; and
a hydrogen generating system coupled to the processor, the processor operable to receive at least one signal from a hydrogen generating system, the processor operable to deliver a current to a hydrogen generating system, wherein the current from the power source triggers the release of hydrogen from the hydrogen generating system by electrolysis, and the processor operable to control the current delivered to the hydrogen generating system in response to the at least one signal from the hydrogen generating system.

38. The system of claim 37, wherein the processor is operably connected to a ground element to provide ground contact.

39. The system of claim 37, wherein the processor is operably connected to a power switch to allow power switch of the hydrogen generating system.

40. The system of claim 39, wherein the power switch comprises a power switch operable to alter the flow of the current to the hydrogen generating system.

41. The system of claim 40, wherein the power switch further comprises at least one indicator operable to display at least one performance variable.

42. The system of claim 37, wherein the hydrogen generating system further comprises a temperature sensor, operably connected to the processor, the temperature sensor operable to determine an internal temperature of the hydrogen generating system.

43. The system of claim 37, wherein the hydrogen generating system further comprises a temperature reducing device, the temperature reducing device operably connected to the processor, the temperature reducing device operable to lower the internal temperature of hydrogen generating system.

44. The system of claim 40, wherein the processor is operable to activate the temperature reducing device if the temperature sensor meets or exceeds a set temperature.

45. The system of claim 41, wherein the set temperature is about 120° F. to about 200° F.

46. The system of claim 41, wherein the set temperature is about 140° F. to about 200° F.

47. The system of claim 41, further comprising a computer operably coupled to the processor, the computer operable to define a set temperature.

48. The system of claim 34, wherein the processor is operably connected to a vehicle, the vehicle comprising an ignition mechanism, a power input, and a parking sensor.

49. The system of claim 45, wherein the processor is operable to alter the flow of electrical current to the hydrogen generating system in response to an ignition signal from the ignition mechanism.

50. The system of claim 46, wherein the processor delays the introduction of electrical current to the hydrogen generating system for a fixed time following recognition of the ignition signal.

51. The system of claim 47, wherein the fixed time is between about two minutes and about five minutes.

52. The system of claim 47, wherein the fixed time is between about three minutes and about four minutes.

53. The system of claim 45, wherein the processor can alter the flow of electrical current to the hydrogen generating system in response to an power signal from the power input.

54. The system of claim 45, wherein the processor can alter the flow of electrical current to the hydrogen generating system in response to a parking signal from the parking sensor.
